(19) United States
(12) Patent Application Publication
(10) Pub. No.: US 2025/0111705 A1
(43) Pub. Date: Apr. 3, 2025

(54) VEHICLE BACKUP CAMERA DATA FOR RISK DETECTION AND COLLISION ANALYSIS

(71) Applicant: State Farm Mutual Automobile Insurance Company, Bloomington, IL (US)

(72) Inventor: Brian N. Harvey, Bloomington, IL (US)

(21) Appl. No.: 18/827,418

(22) Filed: Sep. 6, 2024

Related U.S. Application Data
(60) Provisional application No. 63/541,556, filed on Sep. 29, 2023.
(60) Provisional application No. 63/541,581, filed on Sep. 29, 2023.

(51) Int. Cl. G07C 5/00; B60W 30/09; B60W 30/095; B60W 50/14; G06V 20/58; G07C 5/08

(52) U.S. Cl. CPC G07C 5/008; B60W 30/09; B60W 30/0956; B60W 50/14; G06V 20/58; G07C 5/0808; G07C 5/0866; B60W 2050/143; B60W 2050/146; B60W 2420/403; B60W 2556/45

(57) ABSTRACT

A vehicle-based system may store and analyze image data captured by backup cameras, rear-facing, and/or side-facing cameras on a vehicle, to detect high-risk driving scenarios and/or for use in post-collision analyses. The rear-facing or side-view image data may be analyzed on-vehicle while driving, and/or may be transmitted from the vehicle to a remote server for analysis. The backup image data may be analyzed individually or in conjunction with other vehicle sensor data, telematics data, environment data, and the like. In some cases, a vehicle-based system may detect an on-board event, such as a collision, high-risk scenario, or other vehicle damage, and may transmit the image data to a remote server in response to detecting the event. Additionally or alternatively, the vehicle-based system may analyze the image data on-board the vehicle to detect high-risk driving scenarios, and to determine vehicle control commands to avoid or mitigate the high-risk scenarios.

### CROSS-REFERENCE TO RELATED APPLICATIONS

This application is a non-provisional of and claims priority to U.S. Provisional Patent Application No. 63/541,556, filed on Sep. 29, 2023, and entitled “VEHICLE BACKUP CAMERA DATA FOR RISK DETECTION AND COLLISION ANALYSIS,” and is a non-provisional of and claims priority to U.S. Provisional Patent Application No. 63/542,581, filed on Oct. 5, 2023, entitled “VEHICLE BACKUP CAMERA DATA FOR RISK DETECTION AND COLLISION ANALYSIS,” the disclosures of both of which are incorporated herein by reference in their entirety.

### TECHNICAL FIELD

The present disclosure relates to storing and analyzing image data captured by backup cameras, and/or other rear-facing or side-view cameras on a vehicle. In various examples, the image data may be transmitted to a remote server to be used in a post-collision analysis, and/or may be analyzed on-vehicle to detect and mitigate high-risk driving scenarios.

### BACKGROUND

Vehicles may be equipped with a variety of sensors and vehicle data systems, including cameras, radar, lidar, sonar, inertial sensors, location sensors (e.g., global positioning system (GPS) systems or devices), and the like. These systems may be used to monitor the operations of the vehicle within its driving environment, including performing tasks such as vehicle tracking, assisting the driver to perform various driving maneuvers, and detecting potential collisions and other unsafe driving situations. Certain vehicles may be equipped with additional systems to detect and generate data associated with vehicle performance, actions and/or states, such as telematics systems used for tracking the vehicle's speed, acceleration, braking, steering, etc.

Additionally, other devices that may be traveling with a vehicle may include sensors and other components capable of determining and providing data that may reflect the operation of a vehicle. For example, a smartphone of a vehicle occupant may include sensors to generate data indicating the smartphone's speed, acceleration, location, etc.

While the various sensor data, device data, and environment data captured by these systems may be used to perform particular tasks within their respective vehicle systems, the data from these systems may not be shared or integrated across different systems or components. For example, some vehicles may be equipped with one or more rear-facing and/or side-facing cameras, including backup cameras that may be activated automatically while driving in reverse, rear-view and side-view cameras used by parking assist systems, collision avoidance systems, adaptive cruise control systems, and the like.

Vehicles may also include interior cameras for monitoring the occupants of the vehicle. However, these cameras may be utilized only by their associated vehicle systems, and may not be activated or monitored at other times during the operation of the vehicle. As a result, image data captured by backup cameras, dashboard cameras, side-view cameras, interior cameras, and the like, may not be retained or monitored, even though such data may be potentially valuable for performing tasks such as collision analysis, high-risk scenario detection, driver assessment, etc.

Further, collision analysis techniques, for example, may be subject to inaccuracies due to limited data relating to the environment around the vehicle before and during a collision. For instance, post-collision analyses performed by insurance providers, law enforcement agencies, and/or other investigating entities may attempt to draw conclusions about a vehicle accident and its causes based upon observable damage to the vehicles and road debris, witness statements, and basic telematics data (e.g., speed data, impact time and location, etc.) for the vehicle(s) involved.

As a result, conventional collision analyses may be inaccurate due to incomplete information about the driving conditions, and the positions and behaviors of the other vehicles in the environment, just prior to and during a vehicle collision. Conventional techniques may include additional ineffectiveness, inefficiencies, encumbrances, and other drawbacks.

### BRIEF SUMMARY

To address the deficiencies in conventional post-collision analysis and detection of high-risk driving situations, the techniques described herein may be directed to storing and analyzing image data captured by rear-facing and/or side-facing cameras operating on a vehicle. In some examples, a vehicle-based system may activate a backup camera on the vehicle, and may receive and store the image data captured by the backup camera. The backup image data (e.g., image data captured by the backup camera or other rear-facing camera installed on the vehicle) may be analyzed, either individually or in conjunction with other vehicle sensor data, telematics data, environment data, and the like. As described below in more detail, the backup image data may be analyzed on-board by the vehicle computing systems and/or may be transmitted from the vehicle to a remote server for subsequent analysis. The image data analyses described herein may include, but are not limited to, post-collision analyses, analyses to detect potential collisions or other high-risk driving scenarios, analyses of driving behaviors or driver assessments, etc. Additionally, the techniques described herein can include analyzing the backup image data individually, or in conjunction with various other vehicle sensor data, telematics data, environment data, and the like.

As noted above, in some examples, the techniques herein may include receiving and analyzing image data captured by a backup camera of the vehicle. A backup camera may refer to an integrated camera (e.g., an original equipment manufacturer (OEM) backup camera) of the vehicle, which may be configured to activate automatically when the vehicle is put into reverse. However, these techniques are not limited to being used with integrated vehicle backup cameras. In other examples, the image data may be received from various other rear-facing or side-view cameras of the vehicle, including the cameras integrated into the vehicle for parking assistance (e.g., parallel park-assist, bird's eye parking, etc.), adaptive cruise control, vehicle security and threat detection, passenger monitoring, etc. The techniques described herein may also be applied to receiving and analyzing data from any front-facing cameras of the vehicle (e.g., integrated dashboard cameras, navigation system cameras, etc.) Additionally, these examples are not limited to receiving and analyzing image data from OEM and/or integrated camera systems and accessories of the vehicle, but may also apply to various aftermarket/secondary market cameras or retrofit camera systems installed on the vehicle. Such camera systems may or may not communicate with the primary vehicle computing systems. Accordingly, as used herein, a “backup camera” may refer to any rear-facing or side-facing camera installed on a vehicle, and “backup image data” may refer to image data captured by any rear-facing or side-facing camera of a vehicle.

In some examples, a vehicle-based computer system may receive image data from one or more rear-facing or side-view cameras of the vehicle, and may transmit the image data to a remote server configured to perform various tasks based upon the image data. For instance, a remote server may be configured to use the rear-facing image data when performing post-collision analyses, driver assessments, detection of high-risk driving scenarios, etc. In such examples, the vehicle-based system may be configured to receive and store the rear-facing image data, and/or may analyze the image data on-board to determine trailing vehicle data, environment data, etc.

The vehicle-based system may also be configured to detect particular events, and to transmit the rear-facing image data to the remote server in response to the events. For instance, when the vehicle-based system detects that a collision has occurred at the vehicle, (or when a potential collision is imminent), the system may initiate the transmission of the image data to the remote server. Other events that may cause the vehicle-based system to transmit the image data may include detecting a near-miss collision and/or other dangerous driving situation, and/or detecting damage to the vehicle.

In some cases, the vehicle-based system may also be configured to store a loop of recently captured image data and transmit the image data to the remote server periodically based upon a timer. To transmit the image data to the remote server, the vehicle-based system may use any number of connections and devices, such as wireless connection associated with the backup camera, an Internet connection established by the vehicle's primary computing systems, and/or a mobile device of an occupant of the vehicle.

Additionally or alternatively, the vehicle-based computer system may receive image data from one or more rear-facing or side-view cameras of the vehicle, and may analyze the image data in real-time on the vehicle to detect potential high-risk driving scenarios. In response to detecting a high-risk driving scenario, the vehicle-based system may determine and initiate one or more vehicle control commands to avoid or mitigate the high-risk scenarios. For instance, the vehicle-based system may use heuristic-based rules and/or trained machine-learned models to detect high-risk scenarios for the vehicle based upon the rear-facing (and/or side-facing) image data.

Examples of high-risk scenarios may include a trailing vehicle following too close, having a distracted driver, tight corners in a city's downtown, and/or exhibiting erratic driving behaviors. Additional high-risk scenarios that may be detected by the vehicle-based system can include a potential or imminent collision, and/or hazardous road or weather conditions. As described below, the vehicle-based system may detect high-risk driving scenarios based upon the rear-facing image data (and/or side-facing image data), either alone or in combination with various other vehicle sensor data, telematics data, etc.

In response to detecting a high-risk driving scenario, the vehicle-based system may determine and initiate perform one or more vehicle control commands to avoid or mitigate the high-risk scenario. Such commands may be based upon the particular high-risk scenario and other factors, and include activating the hazard lights or brake lights of the vehicle, providing a notification to the driver, and/or initiating a driving maneuver (e.g., lane-change, acceleration or deceleration).

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts an exemplary computing environment including a vehicle-based system configured to analyze rear-facing image data captured by the vehicle (such as via on-board sensors) and/or transmit the rear-facing image data to a remote server, in accordance with one or more examples of the present disclosure.

FIGS. 2A and 2B depict examples of rear-facing image data captured by a vehicle camera, and associated image analysis data for trailing vehicles perceived within the rear-facing image data, in accordance with one or more exemplary embodiments of the present disclosure.

FIG. 3 depicts an exemplary interior of a vehicle, including an integrated display and a mobile device of the driver, in accordance with one or more exemplary embodiments of the present disclosure.

FIG. 4 depicts three exemplary timelines indicating events associated with capturing, storing, and transmitting rear-facing image data by a vehicle-based system to a remote server, in accordance with one or more exemplary embodiments of the present disclosure.

FIG. 5 is a flowchart illustrating an exemplary computer-based process for capturing rear-facing image data by a vehicle-based system, and/or transmitting the image data to a remote server based upon the detection of an event, in accordance with one or more exemplary embodiments of the present disclosure.

FIG. 6 is a flowchart illustrating another exemplary computer-based process for capturing rear-facing image data, analyzing the image data by the vehicle-based system to detect a potential high-risk driving scenario, and/or performing a vehicle control command based upon the high-risk driving scenario, in accordance with one or more exemplary embodiments of the present disclosure.

FIG. 7 shows an exemplary system architecture for a computing system that may execute one or more elements associated with the vehicle-based system, remote server, user mobile device, and/or other elements described herein.

The detailed description is set forth with reference to the accompanying figures. In the figures, the left-most digit(s) of a reference number identifies the figure in which the reference number first appears. The use of the same reference numbers in different figures indicates similar or identical items or features.

### DETAILED DESCRIPTION

The present embodiments may relate to, inter alia, providing a backup camera recorder for rear-end collision analysis. By way of background, drivers may be involved in a rear-end collision where the driver or vehicle behind them fails to stop in time and causes the collision ultimately resulting in an insurance claim. These types of claims may be costly and time-consuming to handle and resolve. Some drivers and/or vehicles may have a dash cam that may help resolve these claims when the insured is the driver that rear-ended another vehicle. However, in most cases when the insured's vehicle is the one rear-ended, there isn't video-based information.

To assist in claim resolution in a timely and cost-effective manner, using the backup camera of a vehicle may provide valuable information as to who is at fault in a rear-end collision. The present embodiments may leverage existing backup cameras and other sensors in newer model vehicles or be a stand-alone system that may be retrofitted onto any vehicle.

The computer system may record a collision from the perspective of the rear bumper of the vehicle. Other data may be collected, generated, received, and/or combined as well, such as dash cam video, weather data, road conditions (as analyzed by the dash cam and/or backup cam) and vehicle telemetry data (speed, deceleration, cornering, heading, location, etc.). Data regarding the trailing vehicle may also be included, such as distance behind vehicle, closing speed, distracted driving (driver keeps looking down or out the window, etc.).

The system may also recognize a trailing vehicle and retrieve manufacturer performance information to determine if the vehicle would be able to stop in time given the host vehicle's own performance data, the current travelling speed and heading, and/or the trailing vehicle's speed, distance from the host vehicle, and heading. If it is determined that the trailing vehicle would not be able to stop in the required amount of time, this may factor into a proper determination of fault.

These datapoints may all be analyzed in a manner that produces a much richer context than what is currently available in such claim investigations. In certain embodiments, the data types mentioned herein may be constantly streamed to a remote server for analysis, and in the event of a collision, quickly analyzed and provided to on-site law-enforcement officials for the purpose of investigating the accident.

The functionality and capabilities discussed herein may be incorporated into new vehicles, and/or employed via a software update for some existing late model vehicles, utilizing the vehicles built-in sensors, Internet connection (for weather data and streaming data to State Farm). The stand-alone version may provide the same capabilities but use its own sensors to get vehicle telemetry data and video data. The system may have its own Internet connection or could connect to the vehicle's or use the driver's cell phone connection to get external data, such as weather data, smart infrastructure data, other vehicle data, other passenger data, etc. On board processors may use an onboard ML model to analyze the road conditions, distance of trailing vehicle, distracted driver behind this vehicle, etc. This capability may also be extended to trailer cameras that may see behind the vehicle when towing.

The present embodiments may employ several machine learning (ML) models. Exemplary machine learning (ML) models may include capabilities to: (1) analyze road conditions; (2) determine distance of trailing vehicle; (3) identify distracted driver(s) of trailing vehicle(s); (4) impact of weather on a collision or accident; and/or other functionality discussed herein.

The ML model inputs may include: (i) weather impacts on road conditions; (ii) road conditions on stopping distance; (iii) vehicle information (weight, stopping distance, etc.) to profile trailing vehicle; (iv) determine if the trailing vehicle would be able to stop in the required amount of time/distance if following this vehicle at the determined distance; and/or other inputs discussed herein.

One of the outputs of the present embodiments may be a context rich report of the various data points that may be used in subrogation to determine fault of a rear-end collision. The system may also provide a 3D model of the analysis that may be viewed in a Virtual Reality (VR) hood in the Metaverse to help understand the sequence of events in a more immersive way. Additionally or alternatively, extended reality headsets, VR headsets, AR glasses, voice bots, chat bots, ChatGPT bots, or other devices may used to present output, graphical representations, and/or other analysis to a user, including visual or verbal analysis. The output may include representations of the vehicles involved in the collision, as well as other vehicles in the view of the cameras, road conditions, speeds and distances of vehicles, etc.

With the present embodiments, insureds and/or drivers may benefit by having more evidence as to who is at fault in a rear-end collision if they are rear-ended. Insureds and/or drivers may also benefit from an insurance discount for having this capability in their vehicle.

### Exemplary Computer Systems

Techniques are described herein, including computer systems and computer-implemented methods, for, inter alia, capturing, storing, and analyzing image data from rear-facing and/or side-facing cameras on a vehicle. In various examples, the image data may be used for detecting high-risk driving scenarios, performing post-collision analysis, and/or various other purposes.

The techniques described herein may be performed, for instance, by one or more on-board camera systems. As used herein, a camera system (which may also be referred to as an imaging system) may be configured to capture, store, and/or analyze image data from cameras on the vehicles. The camera systems described herein may include cameras, be integrated into cameras on the vehicle, and/or be separate from but configured to interface on-board vehicle cameras. In some examples, a camera system may be integrated into the primary computing systems of the vehicle.

Additionally or alternatively, a camera system may be implemented as separate on-board system that is external to the primary vehicle computers. Examples of on-board camera systems that are external to the vehicle computing systems may include camera accessories for vehicles (e.g., rear-facing or side-facing dashcams), aftermarket and/or retrofit camera systems that include cameras or are configured to interface with the existing cameras integrated into the vehicle.

As an example, a backup camera system may be configured to interface with a backup camera installed on a vehicle (e.g., an OEM factory backup camera, or aftermarket accessory camera). The backup camera system may be capable of activating and de-activating the backup camera, and capturing and storing data from the backup camera for analysis. In some cases, the backup camera system may override the default behaviors of the vehicle computing system with respect to the backup camera, which may include activating the backup camera only when the vehicle is in reverse. As described herein, a backup camera system may activate the vehicle's backup camera at various times when the vehicle is on or off, stationary and/or driving forward.

Although some examples herein relate to controlling a backup camera of a vehicle, and capturing and analyzing image data from the backup camera, additional examples may include similar or identical techniques for any front-facing, rear-facing, or side-facing cameras on a vehicle. These cameras may include the OEM factory cameras integrated into the vehicle for parking assistance, adaptive cruise control, vehicle security and threat detection, passenger monitoring, etc., as well as any aftermarket or retrofit camera accessories installed separately onto the vehicle. As described herein, a backup camera system may be capable of interfacing with any or all on-board vehicle cameras, including controlling the operation of the camera (e.g., activating and deactivating, changing focus, panning or zooming, etc.), as well as interfacing with the cameras to receive the captured image data and/or any associated metadata.

Certain techniques described herein may relate to, inter alia, capturing image data from a rear-facing or side-facing vehicle camera, storing the image data, and/or transmitting the image to a remote server (e.g., an off-vehicle server) for analysis. For instance, a backup camera system may receive images and/or video data from one or more rear-facing or side-facing cameras on the vehicle, and/or store the image data (which may include individual images and/or video) within an internal storage unit of the backup camera system. The image data may be transmitted to the remote server based upon a periodic transmission schedule, and/or in response to an event detected on the vehicle by the backup camera system.

In some cases, the backup camera system may accumulate and retain the image data for a predetermined duration of time (e.g., 10 seconds, 30 seconds, 1 minute, etc.). When the end of the time duration is reached, the backup camera system may transmit the recent image data to the remote server. In other cases, the backup camera system may erase and/or overwrite the older image data, unless the remote server explicitly requests the image data and/or unless an event is detected on the vehicle that causes the backup camera system to transmit the image data or retain the image data within the vehicle-based storage for a longer period of time (or permanently).

In some instances, the backup camera system may be configured to capture and store data received from the vehicle cameras continuously. In other instances, the backup camera system may include logic to activate/deactivate the vehicle cameras, and/or to retain or not retain the image data, in response to certain driving conditions. For example, the backup camera system may be configured to automatically activate one or more rear-facing or side-facing cameras and begin capturing image data immediately when the vehicle is turned on, or when the vehicle begins moving. In other examples, the backup camera system may use additional criteria for determining when to activate the cameras and/or when to store the image data. Such additional criteria may include a speed threshold of the vehicle (e.g., capturing image data when the vehicle speed is greater than 20 MPH, 50 MPH, etc.), and/or an acceleration or braking threshold, in response to a bump or jerk, etc.

Additionally or alternatively, the backup camera system may use criteria for activating the cameras and/or capturing image data based upon the positions and behaviors of other vehicles in the environment. For instance, the backup camera system may automatically begin capturing image data from a rear-facing or side-facing camera in response to another vehicle, or a bicycle or pedestrian, being within a threshold distance of the vehicle. In some instances, the backup camera system may also use criteria for capturing image data based upon detecting a high-risk or dangerous driving condition. Such high-risk conditions may be based upon the current weather conditions, road conditions, traffic conditions, and/or the detection of erratic or distracted driving in the proximity (e.g., within a distance threshold) of the vehicle.

The backup camera system may be configurable, using any of the various techniques herein, with respect to when the rear-facing and side-facing vehicle cameras are activated, how much image data is captured, and how often the image data is purged from the on-vehicle memory and/or transmitted to the remote server. As can be understood, there may be different technical advantages associated with different configurations of a backup camera system. For instance, an always-on configuration in which the backup camera system is continuously capturing and storing data, and in which the data is frequently transmitted back to the remote server, may be highly effective in preserving relevant data for a post-collision analysis even in the event of an unexpected collision and/or a collision in which the on-vehicle memory is damaged or destroyed.

In contrast, various more selective configurations may be used in which the backup camera system is deactivated during low-risk driving conditions, the on-vehicle memory is periodically overwritten, and/or the image data is transmitted to the remote server less frequently (e.g., in response to an event or request from the server). These more selective configurations may improve the overall system performance, may capture more relevant image data, and/or reduce the processing and memory overhead required by the on-vehicle systems, as well as network bandwidth, for image data transmissions to the remote server.

When transmitting the image data from the on-vehicle storage unit to the remote (e.g., off-vehicle) storage, the backup camera system may use any number of data transmission techniques, networks, and/or protocols. In some instances, the backup camera system may include one or more wireless network interface(s) that allow the backup camera system to establish connections with one or more remote server(s) and transmit the image data. Additionally or alternatively, the backup camera system may be configured to use the network interfaces of the primary vehicle computing systems to transmit the image data. In still other examples, the backup camera system may transmit the image data by accessing the network via a mobile device of one of the vehicle's occupants (e.g., a smartphone or tablet), such as a cellular network, mobile hotspot or other wireless network, or via a mobile application relating to the backup camera system or vehicle telematics.

When transmitting the image data from the on-vehicle storage to the remote server, the backup camera system may be configured to (i) periodically transmit the recent image data; (ii) transmit the image data in response to requests from the server; and/or (iii) transmit the image data to the remote server in response to detecting an event on the vehicle. For instance, the backup camera system may include collision or impact sensors, and/or may interface with the collision/impact sensors of the vehicle's primary computing systems and/or telematics systems.

When a collision is detected, the backup camera system may automatically initiate a transmission of the recent image data stored on the vehicle to the remote server, for use in a post-collision analysis. In some cases, the backup camera system may also transmit some or all of the recent image data in response to other types of events (e.g., non-collisions), such as near-miss collisions (e.g., another vehicle within a threshold distance of the vehicle while driving), detections that the vehicle is skidding or sliding, or detections that vehicle damage or an internal system malfunction has occurred (e.g., a flat tire, a broken brake light, etc.). The backup camera system may also transmit the image data based upon the relative positions and/or behaviors of other vehicles in the proximity of the vehicle. For instance, when a trailing vehicle identified in the rear-facing image data is determined to be following too close, driving too fast, driving erratically and/or distractedly, or when another dangerous driving situation is detected, the backup camera system may automatically initiate a transmission of the image data to the remote server.

Both with respect to determining when to capture and store the image data, and when to transmit the image data to the remote server, the backup camera system may be configured to capture and/or transmit data from some on-vehicle cameras but not others, based upon the current driving environment and the events detected around the vehicle. For instance, in the event of a collision, the backup camera system may immediately transmit the image data from the cameras facing the impact surface on the vehicle to the remote server, but may delay transmission of (or not transmit at all) the image data from the cameras facing in other directions. Similarly, for near-miss collisions, vehicles following too close, vehicles driving erratically, or for distracted/impaired drivers, the backup camera system may be configured to capture and/or transmit image data from the cameras covering the other vehicle(s) causing the high-risk scenario, but might not capture and/or transmit image data from other cameras on the vehicle.

In some examples, when the backup camera system transmits image data to the remote server, the system may also transmit additional vehicle data associated with the image data. As described below, in addition to the rear-facing and side-facing cameras used by the backup camera system, the vehicle may also include various additional cameras, sensors, and vehicle telematics. When the backup camera system detects an event that triggers transmitting image data to the remote server, it may also retrieve and transmit additional sensor data and/or telematics from any of the additional vehicle systems. In such cases, the backup camera system may synchronize and correlate the transmitted data, so that the additional sensor data or telematics data represents the same (or similar) period of time, same relative position/angle with respect to the vehicle, etc.

When transmitting the image data to the remote server, the backup camera system may transmit raw image data only, or, additionally or alternatively, may transmit non-image data derived from an on-vehicle analysis of the image data. For instance, instead of (or in addition to) transmitting rear-facing image data of a following vehicle, the backup camera system may analyze the image data to determine various characteristics of the following vehicle. Such characteristics may include, for example, identifying features of the vehicle (e.g., make, model, color, license plate number, etc.), the speed and following distance of the following vehicle, the estimated size and/or weight of the following vehicle, and/or any indications of high-risk driving (e.g., erratic driving, aggressive driving, high-acceleration or braking, distracted driving, impaired driving, etc.). In various examples, to determine potential high-risk driving and other dangerous driving scenarios, the backup camera system may use heuristic rule-based systems and/or trained machine-learned models.

Examples in which the backup camera system performs on-board analyses of the captured image data may provide additional technical advantages in some instances. For example, analyzing the image data on the vehicle prior to transmission to the remote server may allow the backup camera system to make better determinations about which image data should be transmitted to the remote server, which image data should be retained in the on-vehicle memory, and/or which image data can be erased/overwritten. Further, the characteristics of the identified vehicles and any other data derived based upon the image data may be smaller than the raw image data itself. Thus, storing and/or transmitting derived data instead of any or all of the raw image data may result in reduced memory requirements and reduced bandwidth usage.

The various examples above relate to capturing image data from the rear-facing and/or side-facing cameras of the vehicle, and then transmitting the image data to a remote (e.g., off-vehicle) server for further processing. As described below in more detail, the remote server may store the image data (and/or associated derived data, metadata, etc.) in data stores on the server, and may use the image data for subsequent post-collision analysis, driver assessments, detection and analysis of high-risk driving scenarios, and the like.

However, in other examples, the backup camera system may also be configured to analyze the image data captured via the rear-facing and side-facing cameras of the vehicle, to detect and respond to high-risk driving scenarios encountered by the vehicle. In these examples, the backup camera system may perform an on-board analysis of the image data without transmitting the image data to the remote server, and/or may analyze the image data on-board the vehicle while concurrently (e.g., before, during, or after) transmitting the image data to the remote server.

When the backup camera system includes an analysis component to analyze the rear-facing and/or side-facing image data captured on the vehicle, it may use any combination of heuristics and/or trained machine-learned models to detect potential high-risk or dangerous driving scenarios on the vehicle. For example, when detecting a trailing (or following) vehicle in the image data captured by the vehicle's backup camera (or other rear-facing camera), the backup camera system may analyze the image data for the trailing vehicle to determine the vehicle type (e.g., make and model), size, weight, speed, acceleration, following distance, etc.

In some examples, the image analysis component may use a heuristic based upon the speed, trailing distance, and/or size/weight of the trailing vehicle to determine whether it presents a sufficiently high risk of rear-ending the vehicle. The backup camera system may also use one or more trained machine-learned models to detect erratic driving patterns, a distracted or impaired driver, etc. Based upon a combination of this data, and/or various other data such as the current weather conditions, road conditions, etc., the image analysis component may determine whether a trailing vehicle presents a sufficiently high risk to the vehicle. Further, although these high-risk driver scenarios relate to analyzing a trailing vehicle that is driving behind the vehicle, similar or identical techniques may be used to determine high-risk driving scenarios based upon vehicles approaching the vehicle from the side or front, bicycles, pedestrians, and/or static objects (e.g., potholes, road debris, etc.).

When the image analysis component detects a potentially high-risk driving scenario, based upon analyzing the image data, the backup camera system may initiate one or more vehicle control commands to avoid or mitigate the high-risk scenario. The action performed by the backup camera system may be based upon the particular type high-risk scenario, including the vehicle or relative direction of the risk, the likelihood and severity of the risk, etc. For example, if the potential risk corresponds to a trailing vehicle that is following too closely, the backup camera system may briefly turn on the hazard lights, tail lights, and/or brake lights, to alert the trailing vehicle to the potential danger. Additionally or alternatively, depending on the type of the potential risk, the backup camera system may provide an audible warning or visual warning to the driver via a vehicle display system (e.g., in-vehicle entertainment system, navigation system, dashboard warning lights, etc.).

In some instances, the backup camera system may also determine and initiate driving maneuvers in response to a potential high-risk driving scenario. For instance, in response to a trailing vehicle following dangerously close, and/or potential collision from a rapidly approaching vehicle, the backup camera system may initiate a steering maneuver (e.g., lane change or road pull-off maneuver) to allow the dangerous trailing vehicle to pass, and/or may accelerate or decelerate the vehicle when necessary to avoid or mitigate the damage from a potential collision. As another example, when a trailing vehicle is following too close and/or the trailing driver is distracted or impaired, the backup camera system may initiate a configuration of the primary drive components of the vehicle to cause the vehicle to begin braking earlier but to decelerate less aggressively at an upcoming stop, thereby reducing the likelihood that the trailing vehicle will rear-end the vehicle.

As noted above, the backup camera system may analyze the image data individually, or in conjunction with any of the additional sensor data and/or telematics data available on the vehicle. For instance, when using an image analysis component to detect a potential high-risk scenario, the backup camera system may also retrieve and analyze various other camera data on the vehicle, vehicle sensor data, and/or telematics data. The backup camera system may also use additional image data, sensor data, and/or telematics data when selecting the optimal vehicle control commands for responding to a potential high-risk scenario.

### Exemplary Computing Environment

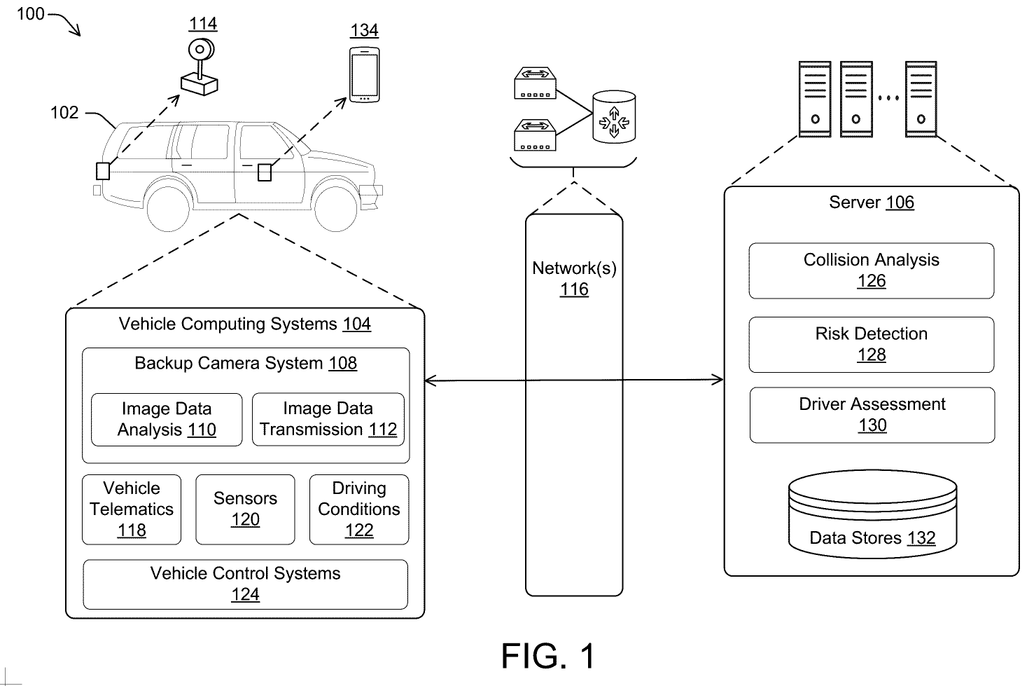

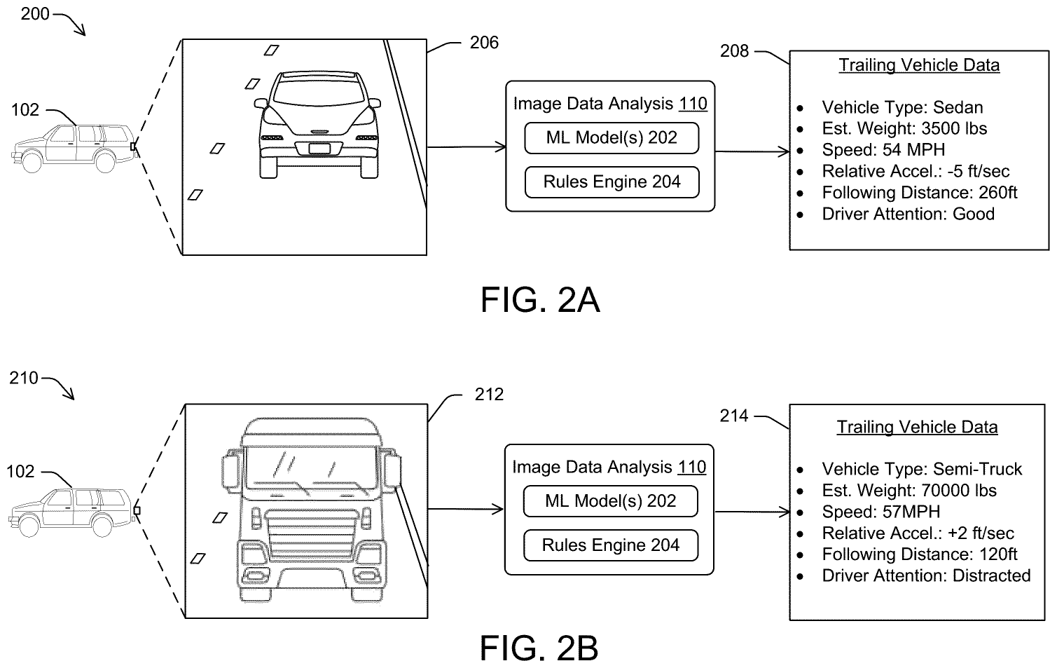

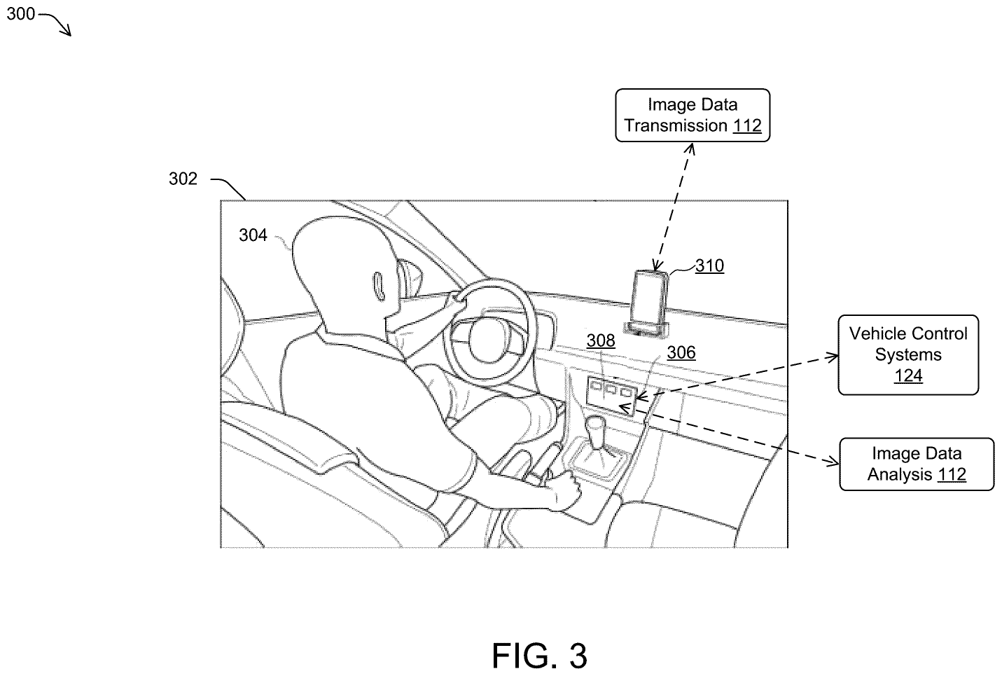

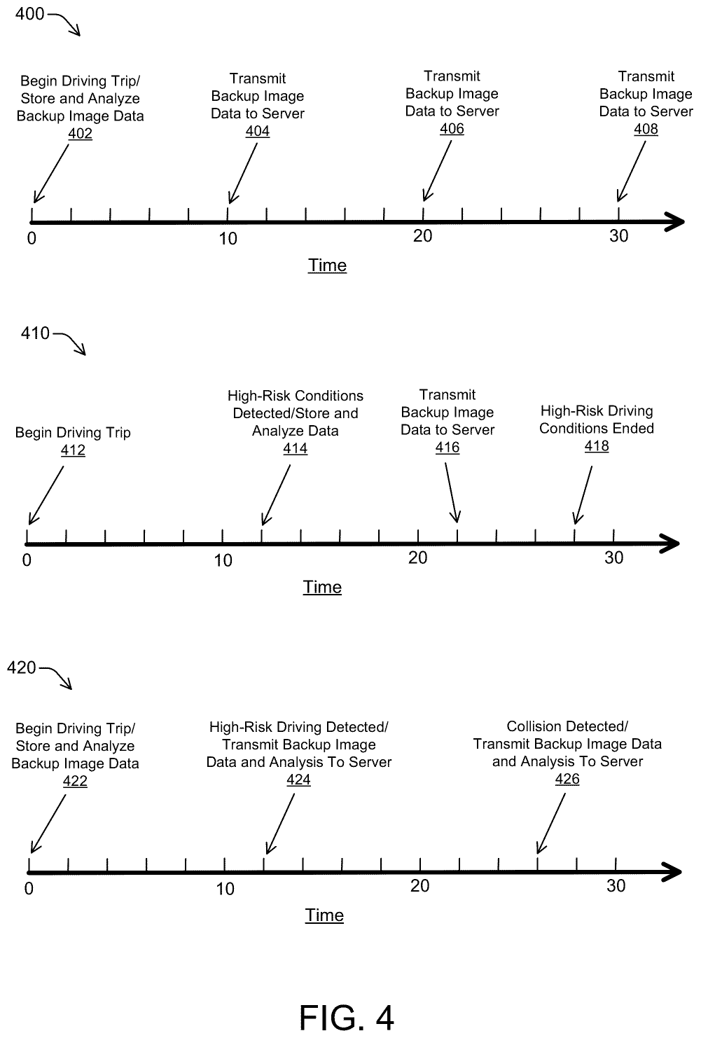

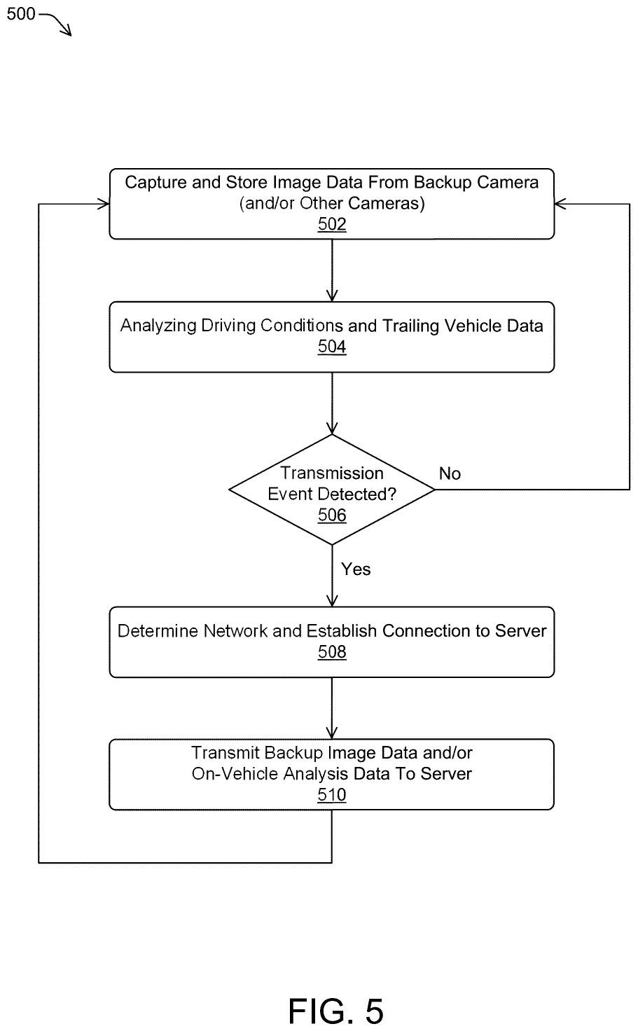

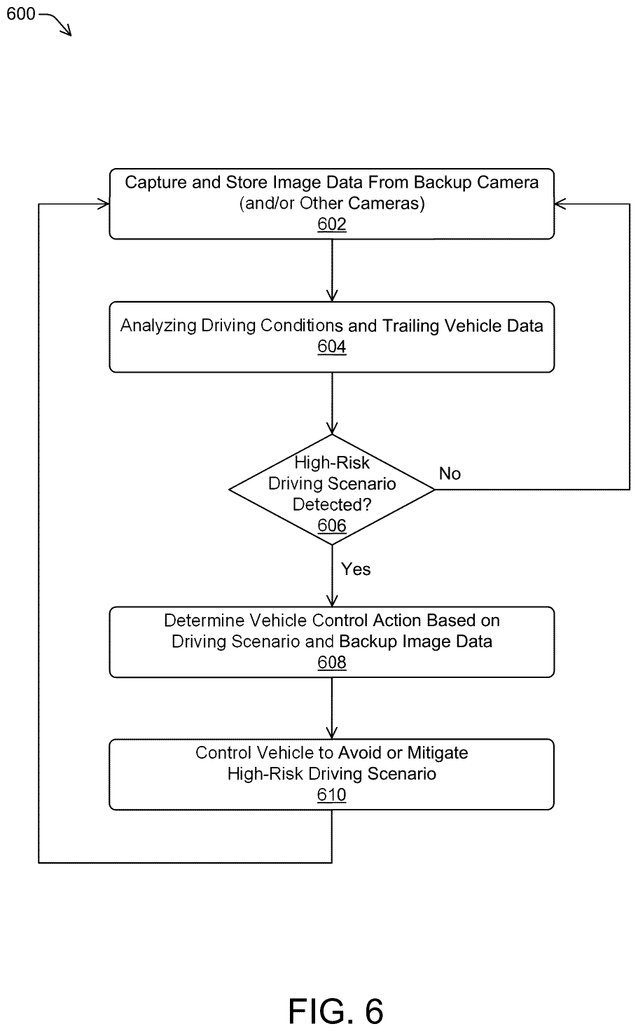

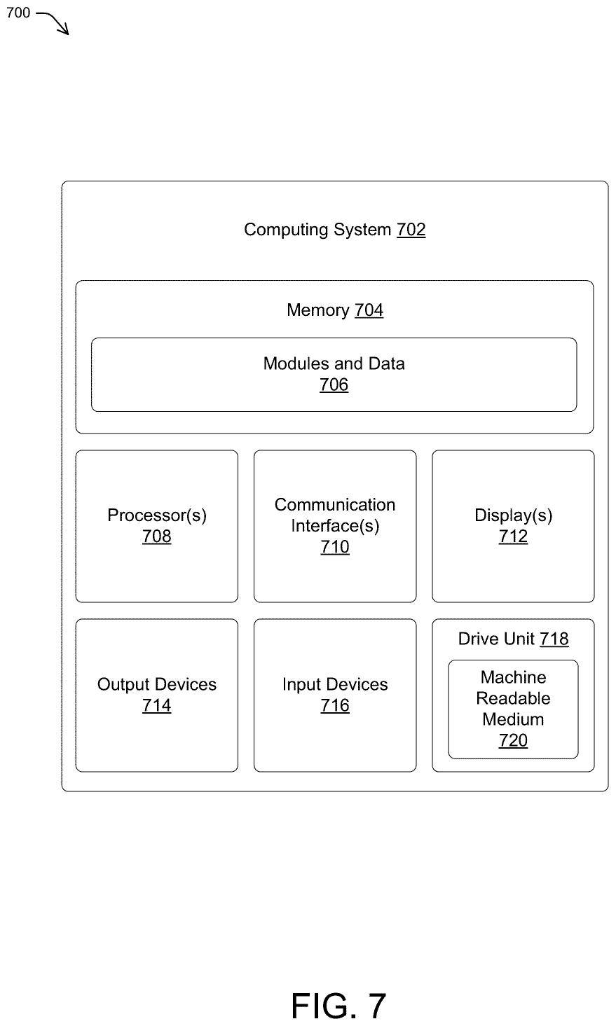

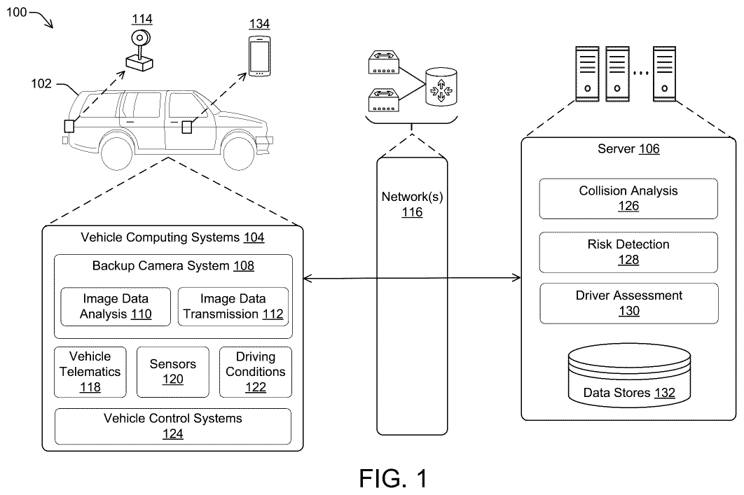

FIG. 1 shows an exemplary computing environment 100 illustrating components configured to perform various techniques described herein. In this example, the computing environment 100 depicts a vehicle 102 including vehicle computing systems 104 configured to monitor and control aspects of the vehicle's operations. As described below, components within the vehicle computing systems 104 may be configured to transmit data to a remote server 106 for various types of analyses. For instance, as described in the examples herein, the vehicle computing systems 104 may include a backup camera system 108 configured to capture and store image data from one or more rear-facing and/or side-facing cameras on the vehicle 102, such as a backup camera 114.

As shown in this example, the backup camera system 108 may include an image data analysis component 110 configured to analyze the rear-facing and/or side-facing image data to detect certain events, driving conditions, high-risk scenarios, etc. The backup camera system 108 may also include an image data transmission component 112 configured to transmit the image data via one or more networks 116 to the remote server 106.

In various examples, the vehicle 102 may be a car, truck, or other type of vehicle. In some examples, the vehicle 102 may be an electric vehicle (EV), hybrid vehicle, or other type of vehicle that is at least partially powered by a battery (e.g., a lithium-ion (Li ion) battery, a lithium-ion polymer battery, a nickel-metal hydride (NiMH) battery, a lead-acid battery, a nickel cadmium (Ni—Cd) battery, a zinc-air battery, a sodium-nickel chloride battery, or another type of battery).

Additionally or alternatively, the vehicle 102 may be at least partially powered by an internal combustion engine (ICE) and/or other elements that consume fuel. For instance, the vehicle 102 may be a hybrid vehicle that is powered at different times by either or both a battery and an ICE. In other examples, the vehicle 102 may be an EV that is fully electric and lacks an ICE.

In some cases, the vehicle 102 may be an autonomous or semi-autonomous vehicle. In these examples, various operations of the vehicle, such as steering, acceleration, braking, and/or other operations, may be fully or partially controlled by an on-board computing system incorporated into the vehicle 102 and/or by other computing elements. In other cases, the vehicle 102 may be manually controlled by a driver, instead of or in addition to being autonomous or semi-autonomous. For instance, the vehicle 102 may have an autonomous mode in which the vehicle 102 drives autonomously without any input from a driver, a semi-autonomous mode in which the vehicle 102 semi-autonomously with minimal or infrequent input from a driver, and/or a manual mode in which the vehicle 102 is driven based upon input from a driver.

As described the backup camera system 108 may control and/or receive image data from the backup camera 114 (as well as any number of additional rear-facing, side-facing, front-facing, and/or interior cameras on the vehicle). The backup camera system 108 may analyze and/or transmit the image data received from these cameras to the remote server 106.

When analyzing the image data received from the backup camera 114 (and/or additional cameras), the backup camera system 108 may also receive data from additional components within or external to the vehicle computing systems 104. The vehicle computing systems 104 in this example also include vehicle telematics 118, sensors 120, driving conditions 122, and vehicle control systems 124. The vehicle telematics 118 may include one or more components configured to generate, collect, and/or receive data from various data sources on the vehicle 102. For example, the vehicle telematics 118 may include components indicating or relating to the vehicle (and/or a mobile device) speed, acceleration, braking; deceleration, turning, time, GPS (Global Positioning System) or GPS-derived location, speed, acceleration, direction, heading, lane, or braking information. Additional vehicle telematics 118 may include data relating to the vehicle 102 and/or vehicle equipment operation, external conditions (e.g., road, weather, traffic, and/or construction conditions), other vehicles or drivers in the vicinity of the vehicle 102, vehicle-to-vehicle (V2V) communications, vehicle-to-infrastructure communications, and/or image and/or audio information of the vehicle and/or a driver before, during, and/or after an accident. The vehicle telematics 118 may collect these data and other types of data discussed herein, via wired or wireless communication.

Sensors 120 may include one or more sensors configured to capture corresponding types of sensor data, user input, or other input data. The sensors 120 may include accelerometers and/or other motion sensors, Global Positioning System (GPS) sensors and/or other location sensors, sensors associated with a transmission and/or braking system of the vehicle 102, cameras and/or other image-based sensors, Light Detection and Ranging (LiDAR) sensors, microphones, proximity sensors, weight sensors, seatbelt sensors, seat pressure sensors, payload sensors, and/or other types of sensors. Sensor data, user input, and/or other input data captured by the sensors 120 may be provided to an on-board computing system of the vehicle 102, such that the on-board computing system may perform autonomous or semi-autonomous operations based upon received sensor data. In some examples, as described herein, sensor data, user input, and/or other input data captured by the sensors 120 may also, or alternately, be provided to the backup camera system 108.

The driving conditions 122 may include components configured to receive and/or determine various aspects of the current driving conditions of the vehicle 102, including the weather conditions, road conditions, traffic conditions, visibility, etc. The driving conditions 122 may include on-vehicle sensors configured to measure the various aspects of driving conditions. The driving conditions 122 may also include additional components configured to receive driving condition data from various external data sources, such as map data sources (e.g., for road surface conditions), weather data sources, traffic data servers, other smart vehicles, mobile devices from passengers in other vehicles, smart infrastructure, aerial vehicles (drones, satellites, airplanes, etc.), etc.

In various examples, some or all of the vehicle telematics 118, sensors 120, and/or driving conditions 122 may be generated by one or more mobile devices 134 operating independently of the vehicle computing systems 104. Such mobile devices 134 may include devices installed in and associated with the vehicle 102 itself (e.g., aftermarket navigation systems, entertainment systems, smart vehicle systems, etc.), and/or the mobile devices of the vehicle's occupants. Examples of mobile devices 134 may include smart phones, cell phones, laptops, tablets, phablets, PDAs (Personal Digital Assistants), computers, smart watches, pagers, hand-held mobile or portable computing devices, smart glasses, smart electronic devices, wearable devices, smart contact lenses, and/or other computing devices), other devices capable of wireless RF (Radio Frequency) communications, and/or other devices or systems that capture image, audio, or other data and/or are configured for wired or wireless communication.

Additionally, certain data used by the backup camera system 108 (e.g., driving conditions 122) may be collected or derived from police or fire departments, hospitals, and/or emergency responder communications; police reports; municipality information; automated Freedom of Information Act requests; and/or other data collected from government agencies and officials. The data from different sources or feeds may be aggregated. The data generated from such data sources may be transmitted, via wired or wireless communication over one or more radio frequency links, to a remote server, such as the remote server 106. In some cases, the remote server 106 and/or associated processors may build a database of the telematics, driving conditions data, and/or other data, and/or otherwise store the data collected.

As described herein, the backup camera system 108 may be configured to receive, store, analyze and/or transmit the image data captured by the backup camera 114 (and/or any other rear-facing, side-facing, front-facing, and/or interior cameras on the vehicle). In some examples, the capturing, storing, and/or transmission of the image data can be performed periodically, at the request of the remote server 106, and/or in response to a collision or other event detected on the vehicle.

To transmit the image data to the remote server 106, the image data transmission component 112 may connect to the remote server 106 via one or more networks 116. As noted above, in this example, the backup camera system 108 may be implemented within the vehicle computing systems 104, and/or an integrated component within the vehicle's primary monitoring and control systems. However, in other examples, the backup camera system 108 may be implemented as a separate and independent computing system that may communicate with the vehicle computing systems 104 via a wired or short-range wireless network. In still other examples, the backup camera system 108 need not communicate at all with the other components in the vehicle computing systems 104. Therefore, when transmitting the image data to the remote server 106, the backup camera system 108 may use network interfaces internal to the backup camera system 108, other network interfaces provided by the vehicle computing systems 104, and/or mobile networks accessed via the mobile devices within the vehicle (e.g., mobile device 134).

The one or more networks 116 may include one or more proprietary networks, a secure public Internet, a virtual private network and/or one or more other types of networks, such as dedicated access lines, plain ordinary telephone lines, satellite links, cellular data networks, or combinations thereof. In certain embodiments when the one or more networks 116 comprises the Internet, data communications may take place via an Internet communication protocol.

Additionally or alternatively, as described herein, the backup camera system 108 may perform various analyses on the image data captured by the backup camera 114 (and/or any other rear-facing, side-facing, front-facing, and/or interior cameras on the vehicle), using the image data analysis component 110. The image data analysis component 110 may include heuristics and/or trained machine-learned models configured to analyze the image data to identify characteristics of other vehicles (e.g., vehicle type, speed, acceleration, following distance, distracted or erratic driving, etc.). Based upon the analyses performed by the image data analysis component 110, the backup camera system 108 may determine to retrain or overwrite certain image data, initiate transmission of the image data to the remote server 106, and/or perform a vehicle control operation via the vehicle control systems 124. As noted above, the image data analysis component 110 may also receive and use data from vehicle telematics 118, sensors, and/or driving conditions 122, to perform any or all of the analyses described herein.

When the backup camera system 108 determines, based upon an analysis of the image data from the backup camera 114, to perform a vehicle control operation on the vehicle 102, it may initiate or request the particular operation via one or more vehicle control systems 124. The vehicle control systems 124 may include exterior and/or internal light and sound emitting systems on the vehicle, including (but not limited to) the vehicle's brake lights, tail lights, hazard lights, interior lights, speakers, horn, display screens, touch screens, haptic feedback systems, and the like. The vehicle control systems 124 may also include the drive systems of the vehicle 102, controlling acceleration, braking, and steering, etc. As described, in various examples, the backup camera system 108 may determine actions to perform, such as activating the vehicle's exterior lights, providing an audible or visual notification to the driver, and/or causing the vehicle to perform a maneuver or follow a different trajectory, based upon the analysis of the backup image data.

When the backup camera system 108 determines to transmit the image data to the remote server 106, the image data may be transmitted as raw images, and/or may be transmitted as derived data or metadata associated with the image data. Such data transmissions may also include transmitting additional associated data, such as related vehicle sensor data, telematics data, etc., corresponding to the same time duration and/or relative position as the image data.

As shown in this example, the remote server 106 may include any number of components and systems configured to store and analyze the image data. In various examples, the remote server 106 may be implemented with a datacenter or within a cloud-based computing environment. In some cases, the remote server 106 may be maintained by an insurance organization, auto manufacturing organization, law enforcement or other governmental entity, to track and analyze vehicle collisions and/or other traffic incidents. In this example, the remote server 106 includes a collision analysis component 126 configured to analyze the image data received from the backup camera system 108 representing collisions, determine fault and liability of the collisions, generate and process insurance claims, and the like. The remote server 106 may also include a risk detection component 128 configured to analyze the image data received from the backup camera system 108 to detect potential high-risk driving scenarios, which may be used to notify drivers, suggest alternate routes, etc. Additionally, in this example, the remote server 106 may also include a driver assessment component 130 configured to analyze the image data received from the backup camera system 108 to assess/score drivers based at least in part on the image data, with respect to safe driving, law abidance, focused/non-distracted driving, aggressiveness, etc. In this example, the remote server 106 may also include one or more data stores 132 configured to store the image data (and/or other associated data described herein) from the vehicle 102 and any number of additional vehicles in a fleet.

### Exemplary Images

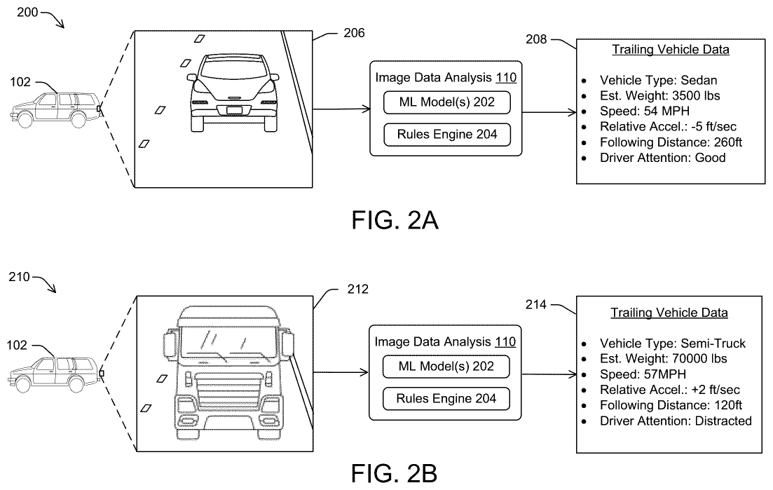

FIGS. 2A and 2B depict two exemplary images that may be captured by a rear-facing camera installed on a vehicle, along with the results of an image analysis performed by a backup camera system 108 based upon the image data. Although the images in these examples may be captured via a backup camera 114 of a vehicle 102, in other examples, the backup camera system 108 may use similar or identical techniques to receive and analyze image data from any other camera on a vehicle 102. Additionally, although the images in these examples show rear-facing images of trailing vehicles that are driving behind the vehicle 102, in other examples, corresponding analyses may be performed for side-facing images, front-facing images, and/or any other angle relative to the vehicle 102.

As described above, when the backup camera system 108 receives image data captured by a backup camera 114 or any other camera on the vehicle 102, it may use an image data analysis component 110 to analyze the image data. As shown in this example, the image data analysis component 110 may include one or more trained machine-learned models 202 and/or a rules engine 204 (e.g., heuristics-based) to analyze the rear-facing image data. For example, the rules engine 204 may include sets of image analysis rules that may be executed by the image data analysis component 110 to determine the relative speed of the trailing vehicle (e.g., relative to the vehicle 102), the relative acceleration of the trailing vehicle, the following distance of the trailing vehicle, etc. The rules engine 204 may also include rules to analyze the image data and estimate vehicle type (e.g., classification), size, and/or weight.

The machine-learned (ML) models 202 may be configured to receive as input the image data captured by the backup camera 114 (and/or image data from any other camera on the vehicle) and to detections of trailing vehicles or associated trailing vehicle data/characteristics. For instance, various ML models 202 may be trained to receive rear-facing image data captured by a vehicle camera, and to output vehicle detections (e.g., whether or not a trailing vehicle is detected), classifications of trailing vehicles (e.g., class, make, model, color, etc.), and/or vehicle identification data (e.g., license plate data, etc.). Such ML models 202 may be generated and trained as individual models or combined (e.g., a single model configured to output both an object detection and classification, etc.).

Additional examples of ML models 202 may include models trained to receive image data and output detections of erratic driving behaviors, distracted or impaired drivers, and the like. In these examples, the input to the ML models 202 may include video data or multiple images over a duration of time, and the ML models 202 may be trained to determine high-risk or erratic driving, distracted driving, etc., based upon various observations of the trailing vehicle over time, including acceleration and braking patterns, lane following behaviors, swerving behaviors, driver reaction time, and/or vehicle following distance, etc.

ML models 202 may be based upon convolutional neural networks (CNNs), recurrent neural networks (RNNs), and/or other types of neural networks suitable for object detection, image analysis, and the like. The ML models 202 may also use ML algorithms including nearest-neighbor algorithms, regression analysis, deep learning algorithms, GBMs, Random Forest algorithms, and/or other types of artificial intelligence or machine learning frameworks. ML models 202 may be trained using various ML training techniques based upon labeled images of vehicles and driving scenes as training data (e.g., rear-facing and side-facing camera data).

Additionally or alternatively, in some embodiments, voice bots or chatbots discussed herein may be used as input and/or output devices, and/or configured to utilize AI (artificial intelligence) and/or ML techniques. An AI chatbot may include at least one of a generative AI chatbot model, a deep learning algorithm, a generative pre-trained transformer (GPT), and a long short-term memory (LSTM) network. For instance, the voicebot or chatbot may be a ChatGPT chatbot.

The voice bots or chatbot may employ supervised or unsupervised machine learning techniques, which may be followed by, and/or used in conjunction with, reinforced or reinforcement learning techniques. The voice bot or chatbot may employ the techniques utilized for ChatGPT.

Noted above, in some embodiments, a chatbot or other computing device may be configured to implement ML, such that a remote server or other computing device “learns” to analyze, organize, and/or process data without being explicitly programmed. ML may be implemented through ML methods and algorithms (“ML methods and algorithms”). In one exemplary embodiment, a ML module may be configured to implement ML methods and algorithms.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, an ML module may employ supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The exemplary inputs and exemplary outputs of the training data may include any of the data inputs or ML outputs described above. In one exemplary embodiment, a processing element may be trained by providing it with a large sample of data with known characteristics or features.

In another embodiment, an ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, an ML module may employ reinforcement learning, which involves optimizing outputs based upon feedback from a reward signal. Other types of machine learning may also be employed, including deep or combined learning techniques.

In FIG. 2A, a first example 200 is shown in which a rear-facing camera of the vehicle 102 has captured image data 206 including a representation of a trailing vehicle. The backup camera system 108 may provide the image data 206 (e.g., as one or more individual images or a video stream) to the image data analysis component 110 for analysis. Based upon the output of one or more ML models 202 and/or heuristics within the rules engine 204, the image data analysis component 110 in this example has determined a first set of trailing vehicle data 208 based upon the image data 206. Within the trailing vehicle data 208, the ML models 202 and/or rules engine 204 of the image data analysis component 110 have determined a vehicle type (e.g., sedan), an estimated vehicle weight (e.g., 2500 lbs), a current speed (e.g., 54 MPH), an acceleration relative to the vehicle 102 (e.g., −5 feet/second), a following distance behind the vehicle 102 (e.g., 260 feet), and a driver attention score (e.g., Good).

Based upon the trailing vehicle data 208, the backup camera system 108 may determine that the trailing vehicle shown in image data 206 does not present a significant risk to the vehicle 102. As described in the examples herein, the backup camera system 108 may perform appropriate operations based upon this determination, such as not alerting the driver of the vehicle 102 or taking any other mitigating action to avoid a potential collision. In this case, the backup camera system 108 may also determine that the image data need not be transmitted to the remote server 106 at this time, and/or may be erased or overwritten within the on-vehicle storage unit.

In FIG. 2B, a second example 210 is shown in which the rear-facing camera of the vehicle 102 has captured image data 212 including a representation of a different trailing vehicle. As in the previous example, the backup camera system 108 may receive and provide the image data 212 (e.g., as one or more individual images or a video stream) to the image data analysis component 110 for analysis. Based upon the output of the ML models 202 and/or rules engine 204, the image data analysis component 110 in this example has determined a second set of trailing vehicle data 214 based upon the image data 212. Within the trailing vehicle data 214, the ML models 202 and/or rules engine 204 of the image data analysis component 110 have determined a vehicle type (e.g., semi-truck), an estimated vehicle weight (e.g., 70,000 lbs.), a current speed (e.g., 57 MPH), an acceleration relative to the vehicle 102 (e.g., +2 feet/second), a following distance behind the vehicle 102 (e.g., 120 feet), and a driver attention score (e.g., Distracted).

In contrast to the previous example, based upon the trailing vehicle data 214, the backup camera system 108 may determine that the trailing vehicle shown in image data 212 does present a significantly high risk to the vehicle 102. As described in the examples herein, the backup camera system 108 may perform appropriate operations based upon this determination, such as alerting the driver of the vehicle 102, activating one or more external lights on the vehicle, and/or taking any other mitigating action to avoid to a potential collision (e.g., lane changes, alternative trajectories, etc.). In such cases, the backup camera system 108 may also initiate a transmission of the image data 212 to the remote server 106, and/or may save/retain the image data 212 in a long-term storage (e.g., not to be overwritten within a normal recording loop) within the on-vehicle storage unit.

### Exemplary Vehicle Interior

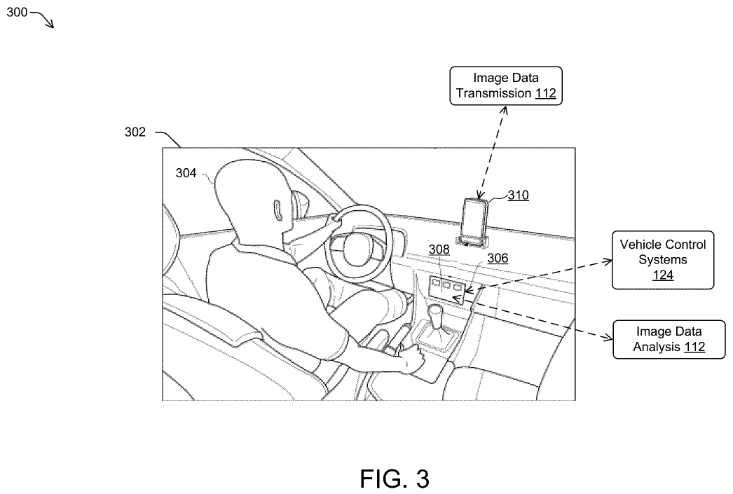

FIG. 3 shows an exemplary depiction 302 of the interior of a vehicle 102, including a driver 304, a vehicle monitoring system 306, an interior display system 308, and a mobile device 310 in a dashboard-mounted phone holder. As described above, in some examples, a backup camera system 108 may operate entirely separately and independently from any other on-board vehicle computing systems, as well as the mobile devices of the driver 304 and other occupants. For instance, the backup camera system 108 may operate as an independent system configured to automatically capture, store, and transmit rear-facing image data to the remote server 106, either periodically or in response to a collision or other event detected by the backup camera system 108. In such examples, the backup camera system 108 may operate entirely transparently without any input from or interaction with the driver 304, the driver's mobile device 310, and/or other any on-board vehicle systems.

However, in other examples the backup camera system 108 may be integrated into and/or may interface with other on-board vehicle computing systems and/or occupant mobile devices in various ways. As shown in this example, the image data analysis component 110 may interface with the integrated vehicle monitoring system 306 of the vehicle 102, including retrieving sensor data, vehicle telematics data, and the like to analyze in conjunction with the image data captured by the vehicle cameras. Additionally, when the backup camera system 108 determines that a notification and/or alert should be provided to the driver 304 based upon the analysis of the trailing vehicle (e.g., following too close, driving erratically or distracted driving) or other high-risk driving scenario, the vehicle control systems 124 may provide the alert via the interior display system 308 of the vehicle 102, and/or via the driver's mobile device 310.

Further, as shown in this example, when the backup camera system 108 performs transmissions of image data to the remote server 106, it may transmit the data via the driver's mobile device 310. In some cases, in the event of a collision or other event detected on the vehicle 102, the backup camera system 108 may transmit the image data (e.g., raw images and/or derived or analyzed data) to the driver's mobile device 310. For instance, after a collision where the vehicle 102 is badly damaged or no longer drivable, it may be advantageous to move the captured image data on the mobile device 310 where they can be preserved securely and more easily accessible to the driver 304. Additionally or alternatively, the image data may be transmitted from the backup camera system 108 to the remote server 106, via the mobile network of the mobile device 310. The transmission to the remote server 106 can be initiated automatically by the backup camera system 108, or the mobile device 310 may be configured to transmit the image data in response to a command from the driver 304 and/or based upon a request from the remote server 106.

### Exemplary Sequences of Events

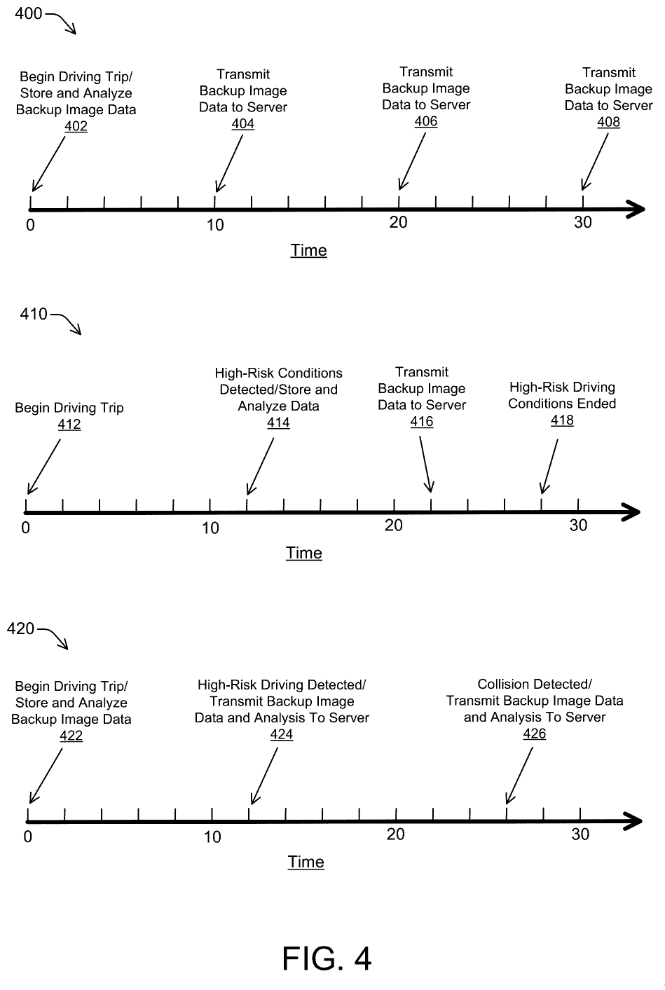

FIG. 4 shows three timelines representing exemplary sequences of events associated with the capturing, storing, and transmitting of image data by a backup camera system 108. As discussed above, the backup camera system 108 may operate in various different ways to capture, store, analyze, and transmit image data received from a backup camera 114 (and/or any other camera) of the vehicle 102. In various examples, each of the operations of activating (or deactivating or otherwise controlling) a vehicle camera, storing (or overwriting) the image data from the camera, performing an analysis of the image data, and/or transmitting the image data to a remote server 106, may be performed (i) automatically whenever the vehicle 102 is operating, (ii) based upon predetermined schedule, and/or (iii) in response to the detection of particular events or states detected on the vehicle 102.

As a first example, timeline 400 depicts a first configuration in which the backup camera system 108 is configured to operate in an always-on mode for capturing and storing image data on the vehicle, including a periodic loop for transmitting the image data back to the remote server 106. In this example, at time 402 (t=0 seconds), the vehicle 102 begins a driving trip and the backup camera system 108 automatically begins storing and analyzing backup image data received from the backup camera 114 (and/or other vehicle cameras). The storage and analysis of the image data may include any of the techniques described herein, including identifying and analyzing the trailing vehicle characteristics, identifying erratic vehicles and distracted drivers in the proximity of the vehicle 102, and/or detecting other high-risk driving scenarios.

In this example, as the driving trip continues, the backup camera system 108 may be configured to transmit the backup image data to the remote server 106 at periodic (e.g., 10-second) intervals. Therefore, at time 404 (t=10 seconds), time 406 (t=20 seconds), and time 408 (t=30 seconds), the backup camera system 108 may transmit the previous ten seconds of image data to the remote server 106 (e.g., the image data stored by the backup camera system since the previous transmission). As discussed above, the transmissions of backup image data may include the raw image data (e.g., images and/or video), the output of the on-board analysis of the image data (e.g., trailing vehicle characteristics, etc.), or a combination of raw image data and analysis output data. The data transmissions may also include associated sensor data, vehicle telematics data, etc.

As a second example, timeline 410 depicts a second configuration in which the backup camera system 108 is configured not to continuously capture and store image data on the vehicle. Instead, in this example, the backup camera system 108 may be configured to activate particular camera(s) and/or store the image data received from the cameras, in response to a high-risk driving condition being detected at the vehicle. Therefore, at time 412 (t=0 seconds), the vehicle 102 begins a driving trip but the backup camera system 108 is not yet storing or analyzing any backup image data. At time 414 (t=12 seconds), the backup camera system 108 determines that the vehicle is driving in high-risk driving conditions, and in response, begins storing and analyzing the backup image data received from the backup camera 114. As described above, examples of high-risk driving conditions that the backup camera system 108 may detect can include speed thresholds, acceleration thresholds, a bump or jerk, skidding or swerving by the vehicle 102, etc.

In this example, after the backup camera system 108 begins storing and analyzing the backup image data at time 414, it may periodically transmit the image data (e.g., raw image data or analysis results) back to the remote server 106. In this example, at time 416 (t=22 seconds), the backup camera system 108 may transmit the previous ten seconds of image data to the remote server 106 (e.g., the image data stored since the beginning of the storing and analyzing at time 414). Shortly thereafter, at time 418 (t=28 seconds), the backup camera system 108 determines that the vehicle is low longer driving in high-risk driving conditions. In response, at time 418 the backup camera system 108 may stop storing and analyzing the image, and may also stop the periodic transmissions of the image data back to the remote server 106.

As a third example, timeline 420 depicts a third configuration in which the backup camera system 108 is configured to transmit the backup image data not periodically, but only in response to detecting particular events (e.g., collisions, high-risk or erratic driving events, etc.) at the vehicle 102. In this example, at time 422 (t=0 seconds), the vehicle 102 begins a driving trip and the backup camera system 108 automatically begins storing and analyzing the backup image data in real-time (or near real-time). At time 424 (t=12 seconds), the backup camera system 108 determines, based upon the analysis, high-risk driving by a vehicle trailing the vehicle 102 (e.g., erratic or distracted driving, a near-miss collision, following too close, etc.). In response to the detection at time 424, the backup camera system 108 transmits the previous twelve seconds of image data to the remote server 106, and continues storing and analyzing the backup image data. Then, at time 426 (t=16 seconds), the backup camera system 108 detects a collision involving the vehicle 102. In response to the collision detection at time 426, the backup camera system 108 transmits the previous fourteen seconds of image data to the remote server 106 (e.g., the image data stored since the previous transmission).

### Exemplary Backup Image Data Transmission Process

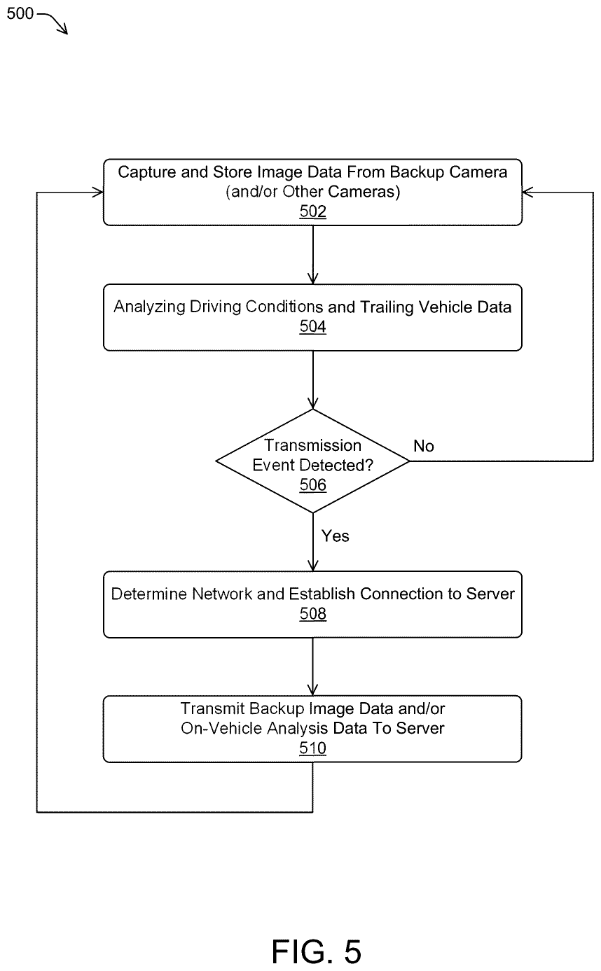

FIG. 5 is a flow diagram illustrating an exemplary computer-based process 500 of storing image data captured by a backup camera (and/or other rear-facing or side-facing cameras on a vehicle), and transmitting the image data to a remote (e.g., off-vehicle) server. In various examples, some or all of the operations of process 500 may be performed by a backup camera system 108 operating within a vehicle 102. As described above, in some examples, the backup camera system 108 may be integrated within the existing internal computing systems of the vehicle 102, such as an OEM factory feature of the vehicle 102 configured to control and receive data from the vehicle's integrated backup camera. In other examples, the backup camera system 108 may operate as a separate and independent computer system, such as an aftermarket camera accessory with processors and wired or wireless transmission capabilities.

At operation 502, the backup camera system 108 may receive and store image data captured by one or more cameras of the vehicle 102. As noted above, although this example describes receiving image data from the vehicle's backup camera, similar or identical techniques may be used to receive image data from any cameras installed on the vehicle. The various cameras from which data is received in operation 502 can include rear-facing, side-facing, or front-facing cameras (or any combination thereof), and may include cameras integrated into the vehicle's internal computing systems and/or cameras separately installed as vehicle accessories.

In some examples, operation 502 may include the backup camera system 108 activating (e.g., turning on) or otherwise controlling (e.g., panning, zooming, focusing, etc.) the cameras to capture the desired image data. For example, when the backup camera 114 is an integrated backup camera controlled by the vehicle 102, the backup camera system 108 may transmit a request to activate and run the camera even when the vehicle 102 is stationary or moving forward. In various examples, the backup camera system 108 may be configured to continuously store and retain the image data, and/or to periodically overwrite the data after a duration of time (e.g., 10 seconds, 30 seconds, etc.) in a continuous loop.

Operation 502 may be performed whenever a driving trip begins and throughout the duration of the driving trip. In other examples, backup camera system 108 might only capture and/or store the image data in operation 502 in response to detecting certain conditions on the vehicle 102. For instance, the backup camera system 108 may be configured to activate the camera and/or store the image data in response to detecting that the vehicle has exceeded a speed threshold, acceleration or deceleration threshold, encountered a bump or jerk, driving in adverse weather or road conditions, or any other driving condition or threshold described herein.

At operation 504, while the backup camera system 108 is receiving image data from the vehicle camera(s), backup camera system 108 may also analyze the current driving conditions and/or the received image data to identify one or more events that may trigger the transmission of the image data to a remote server 106. For instance, an analysis of the driving conditions may include the current road conditions, weather conditions, traffic conditions, as well as the other vehicle and objects in the immediate proximity of the vehicle 102. In some examples, the rear-facing image data may be analyzed real-time or near real-time to determine trailing vehicle data. The trailing vehicle data may include identifying a trailing vehicle within the rear-facing image data, the trailing vehicle representing a vehicle that is driving behind the vehicle 102. The trailing vehicle data may also include the characteristics of the trailing vehicle determined based upon the image data analysis, such as vehicle identifiers, make and model, vehicle type, vehicle speed and relative acceleration, following distance, etc.

In some examples, the backup camera system 108 may analyze the image data to determine trailing vehicle data for a single trailing vehicle only. However, in other examples, the backup camera system 108 may determine corresponding vehicle data for any number of vehicles and/or other objects in the driving environment, including one or more trailing vehicles, nearby vehicles on the side or front of the vehicle 102, and/or other types of nearby objects (e.g., pedestrians and/or bicycles) at any angle relative to the vehicle 102. For each object identified, the image analysis in operation 504 may include analyzing the position and movement of the object relative to the vehicle 102. In some cases, the image analysis may also include detecting erratic behavior, distracted or impaired drivers, etc.

The analysis of the driving conditions and/or trailing vehicle data in operation 504 may be optional in some embodiments. For instance, a backup camera system may be configured to receive, store, and transmit the backup image data to a remote server 106 based upon a schedule or in response to detecting an event on the vehicle 102 (e.g., a collision). In such cases, no analysis of the driving conditions and/or the trailing vehicle data may be needed. However, when such analyses are performed in operation 504, they can provide valuable data for the backup camera system 108 to use to make determinations such as when to retain or overwrite older backup image data, when to transmit the image data to the remote server 106, and/or when to perform a vehicle control command on the vehicle 102 to avoid or mitigate a potential collision or other high-risk scenario.

At operation 506, the backup camera system 108 determines whether an event has occurred that requires the transmission of the event data to one or more remote servers. As noted above, the transmission of the backup image data may be triggered by any number of events, such as detection of collisions, near-miss collisions or imminent collisions, potential (but uncertain) future collisions, damage to the vehicle 102, skidding or swerving by the vehicle 102, detections of dangerous driving scenarios, detections of high-risk driving by a trailing vehicle, and the like. A determination of a transmission event in operation 506 (e.g., an event triggering or associated with a requested transmission of image data) may be based upon the analysis of the driving conditions and/or trailing vehicle data in operation 504. Additionally or alternatively, determining a transmission event in operation 506 can be based upon outputs from various other systems on the vehicle 102 (e.g., sensor systems, telematics, requests from the vehicle's driver via a mobile device or the vehicle dashboard user interface, etc.)

When the backup camera system 108 determines that no such event has occurred (506: No), the process may return to operation 502 to continue receiving image data from the vehicle's camera. In some examples, after a period of time when the image data is not transmitted to the remote server 106, the backup camera system 108 may periodically erase or overwrite the oldest portion of the image data.

However, when the backup camera system 108 determines that an event has occurred that requires transmission of the image data (506: Yes), then in operation 508 the backup camera system 108 may determine a network and establish a connection to the remote server. In various examples, the backup camera system 108 may establish network connections via its own wireless network interface(s), by using the network interfaces of the vehicle's computing systems, and/or by accessing a mobile network via a mobile device of one of the vehicle's occupants (e.g., a via a mobile application relating to the backup camera system or vehicle telematics).

Then, at operation 510, the backup camera system 108 may transmit the backup image data to the remote server 106. In various examples, the image data transmitted in operation 510 may be raw image data (e.g., images and/or video), and/or may be transmitted as derived data or output data from an on-vehicle analysis of the image data (e.g., trailing vehicle data, following distance data, etc.). The transmissions of backup image data in operation 510 may also include transmitting associated sensor data, vehicle telematics data, etc. (e.g., corresponding to the same time period and/or relative position to the vehicle 102 as the transmitted image data).

### Exemplary Backup Image Data Analysis Process

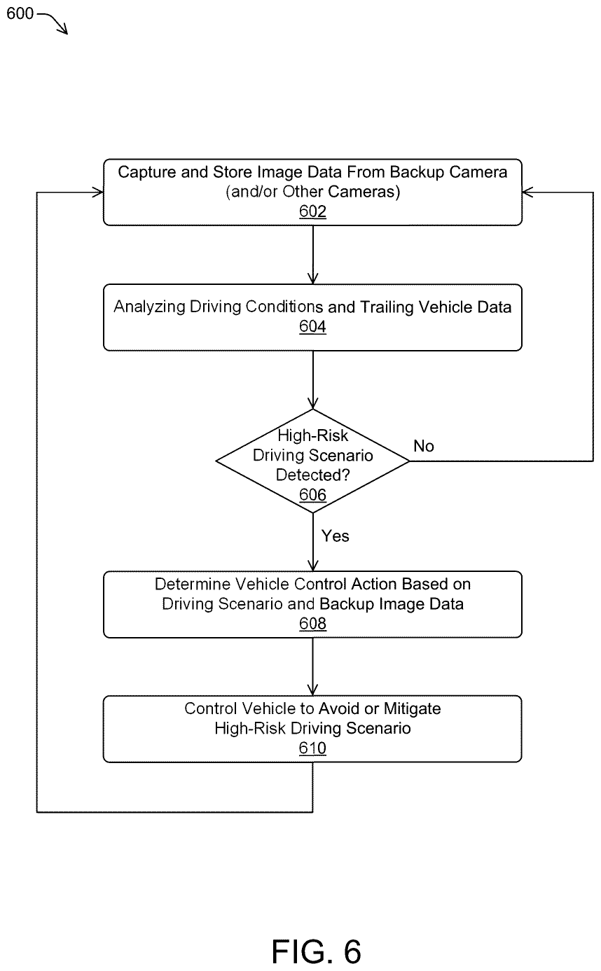

FIG. 6 is a flow diagram illustrating another exemplary computer-based process 600 of storing image data captured by a backup camera (and/or other rear-facing or side-facing cameras on a vehicle), and performing an on-vehicle analysis of the image data to determine and respond to potentially high-risk driving scenarios. As described below, some or all of the operations of process 600 may be performed by a backup camera system 108 operating within a vehicle 102. As described above, in some examples, the backup camera system 108 may be integrated within the existing internal computing systems of the vehicle 102, such as an OEM factory feature of the vehicle 102 configured to control and receive data from the vehicle's integrated backup camera. In other examples, the backup camera system 108 may operate as a separate and independent computer system, such as an aftermarket camera accessory with processors and wired or wireless transmission capabilities.

The techniques described in process 600 may be performed as an alternative to, or in conjunction with, the techniques of process 500 described above. That is, a backup camera system 108 may store and transmit rear-facing or side-facing image data to a remote server 106 in response to an event, while performing minimal or no analysis of the image data. In other examples, the backup camera system 108 may analyze the image data on-vehicle and perform vehicle control commands without transmitting the image data to a remote server. In still examples, the backup camera system 108 may analyze the image data on-vehicle, both for the purpose of performing vehicle control operations based upon the image data and for transmitting at least a portion of the image data to an off-vehicle server.

At operation 602, the backup camera system 108 may receive and store image data captured by one or more cameras of the vehicle 102. In various examples, operation 602 may be similar or identical to operation 502 described above. For example, the backup camera system 108 may receive image data from the vehicle's backup camera and/or any other cameras installed on the vehicle. Such cameras can include rear-facing, side-facing, or front-facing cameras (or any combination thereof), and may include cameras integrated into the vehicle's internal computing systems and/or cameras separately installed as vehicle accessories.

In some cases, operation 602 may include the backup camera system 108 activating or otherwise controlling the cameras to capture the desired image data. As described above, the operation 602 may be initiated by the backup camera system 108 when a driving trip begins on the vehicle 102, or alternatively, may be initiated only when the vehicle 102 is operating in certain driving conditions (e.g., based upon a speed threshold, acceleration or deceleration threshold, encountered a bump or jerk, driving in adverse weather or road conditions, or any other driving condition or threshold described herein).

At operation 604, while the backup camera system 108 is receiving image data from the vehicle camera(s), the backup camera system 108 may also analyze the current driving conditions and/or the received image data to identify one or more events that may represent a potential high-risk driving scenario. For instance, an analysis of the driving conditions may include the current road conditions, weather conditions, traffic conditions, as well as the other vehicle and objects in the immediate proximity of the vehicle 102. In some examples, the rear-facing image data may be analyzed real-time or near real-time to determine trailing vehicle data. The trailing vehicle data may include identifying a trailing vehicle within the rear-facing image data, the trailing vehicle representing a vehicle that is driving behind the vehicle 102. The trailing vehicle data may also include the characteristics of the trailing vehicle determined based upon the image data analysis, such as vehicle identifiers, make and model, vehicle type, vehicle speed and relative acceleration, following distance, etc.

As noted above, the backup camera system 108 may analyze the image data to determine trailing vehicle data for a single trailing vehicle only. However, in other examples, the backup camera system 108 may determine corresponding vehicle data for any number of vehicles and/or other objects in the driving environment, including any number of trailing vehicles, other vehicles on the side or front of the vehicle 102, and/or other nearby objects (e.g., pedestrians and/or bicycles). For any or all of the identified objects, the image analysis in operation 604 can include analyzing the position and movement of the object relative to the vehicle 102, detecting erratic behavior, distracted or impaired driving, etc.

At operation 606, the backup camera system 108 determines, based upon the analysis of the backup image data in operation 604, a potential high-risk driving scenario can be detected. As described above, examples of high-risk scenarios may include potential or imminent collisions between the vehicle 102 and one or more approaching vehicles. Additional examples of high-risk scenarios that may be detected in operation 606 may include (but are not limited to) detecting a trailing vehicle that is following too close, detecting a distracted driver, impaired driver, or a vehicle driving erratically, turning around or tight corners, and/or determining hazardous road or weather conditions. The backup camera system may detect potential high-risk driving scenarios in operation 606, based upon the backup image data (e.g., rear-facing image data), either alone or in combination with various other vehicle camera data, sensor data, telematics data, driving condition data, etc.

When the backup camera system 108 determines that no potential high-risk driving scenario has been detected (606: No), the process may return to operation 602 to continue receiving image data from the vehicle's cameras. In some examples, after a period of time when the image data is not transmitted to the remote server 106, the backup camera system 108 may periodically erase or overwrite the oldest portion of the image data.

However, when the backup camera system 108 determines that a high-risk driving scenario has been detected based upon the image data (606: Yes), then in operation 608 the backup camera system 108 may determine one or more vehicle control commands to avoid and/or mitigate the potential high-risk scenario. Subsequently, at operation 610, the backup camera system 108 may control the vehicle (e.g., requesting or initiating a vehicle control command via the internal vehicle control systems 124 of the vehicle 102). The vehicle control command (or commands) determined in operation 608 may be based upon the particular high-risk scenarios detected, the corresponding vehicle or relative direction of the risk, the likelihood and severity of the risk, etc. For example, vehicle commands determined by the backup camera system 108 may include turning on one or more exterior lights of the vehicle 102 (e.g., hazard lights, tail lights, brake lights, etc.), providing an audible and/or visual warning to the driver of the vehicle 102, and/or performing driving maneuvers (e.g., lane changes, accelerations, braking maneuvers, etc.) to avoid or mitigate the potential high-risk scenario.

### Exemplary Computer System Architecture

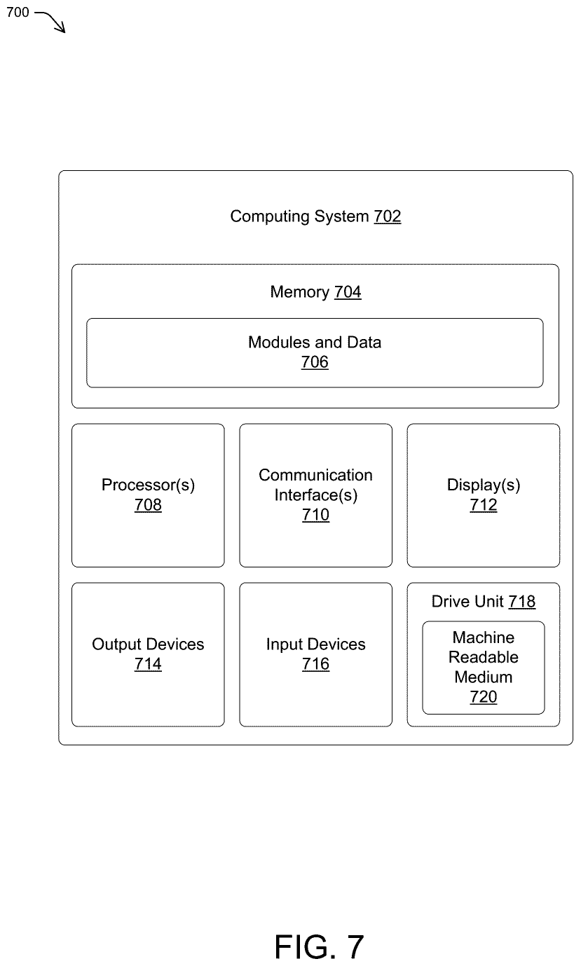

FIG. 7 shows an exemplary system architecture 700 for a computing system 702 that may execute one or more elements associated with the backup camera system 108, a remote server 106, a mobile device 134 and/or various other elements described herein. In some examples, the computing system 702 may be a user device, such as a smartphone, computer, AR (Augmented Reality) glasses or headset, or other type of computing device. In other examples, the computing system 702 may be an on-board computing system of the vehicle 102, such as a computing system that executes a vehicle dashboard system, and engine control unit (ECU) and/or other vehicle systems. In still other examples, the computing system 702 may be a server or element of a cloud computing system that is separate and/or remote from a user device and/or the vehicle 102. The computing system 702 may include one or more computers, servers, or other types of computing devices.

Individual computing devices of the computing system 702 may have the system architecture 700 shown in FIG. 7, or a similar system architecture. In some examples, elements of the backup camera system 108, such as an image data analysis component 110, an image data transmission component 112, and related components including vehicle control systems 124 and/or other elements described herein, may be distributed among, and/or be executed by, multiple computing systems or devices similar to the computing system 702 shown in FIG. 7.

The computing system 702 may include memory 704. In various examples, the memory 704 may include system memory, which may be volatile (such as RAM), non-volatile (such as ROM, flash memory, etc.) or some combination of the two. The memory 704 may further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media.

Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which may be used to store desired information and which may be accessed by the computing system 702. Any such non-transitory computer-readable media may be part of the computing system 702.

The memory 704 may store modules and data 706, including software or firmware elements, such as data and/or computer-readable instructions that are executable by one or more processor(s) 708. As an example, the memory 704 may store computer-executable instructions and data associated with one or more elements associated with the backup camera system 108, such as the image data analysis component 110, image data transmission component 112, vehicle telematics 118, sensors 120, driving conditions 122, and/or vehicle control systems 124. Additionally or alternatively, the memory 704 may store computer-executable instructions and data associated with the remote server 106. As yet another example, the memory 504 may store computer-executable instructions and data associated with one or more mobile devices 134.

The modules and data 706 stored in the memory 704 may also include any other modules and/or data that may be utilized by the computing system 702 to perform or enable performing any action taken by the computing system 702. Such modules and data 706 may include a platform, operating system, and applications, and data utilized by the platform, operating system, and applications.

The computing system 702 may also have processor(s) 708, communication interfaces 710, a display 712, output devices 714, input devices 716, and/or a drive unit 718 including machine-readable media 720.

In various examples, the processor(s) 708 may be a central processing unit (CPU), a graphics processing unit (GPU), both a CPU and a GPU, or any other type of processing unit. Each of the one or more processor(s) 708 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 708 may also be responsible for executing computer applications stored in the memory 704, which may be associated with types of volatile (RAM) and/or nonvolatile (ROM) memory.

The communication interfaces 710 may include transceivers, modems, network interfaces, antennas, and/or other components that may transmit and/or receive data over networks or other connections. The communication interfaces 710 may be used to exchange data between elements described herein. For instance, in some examples, the communication interfaces 710 may receive user input and/or sensor data, and/or may transmit or receive data via cellular networks, wireless networks, and/or other networks. For example, the communication interfaces 710 may be used to access one or more types of information from devices and/or data sources external to the computing system 702.

The display 712 may be a liquid crystal display, or any other type of display used in computing devices. In some examples, the display 712 may be a screen or other display of a dashboard system of the vehicle 102, a display of a mobile device 134, and/or another display associated with a backup camera system 108. The output devices 714 may include any sort of output devices known in the art, such as the display 712, speakers, a vibrating mechanism, and/or a tactile feedback mechanism. Output devices 714 may also include ports for one or more peripheral devices, such as peripheral speakers and/or a peripheral display. In some examples, output of one or more of the driver notifications and/or alerts described herein may be presented via the display 712 and/or the output devices 714.

The input devices 716 may include any sort of input devices known in the art. For example, input devices 716 may include a microphone, a keyboard/keypad, and/or a touch-sensitive display, such as a touch-sensitive display screen. A keyboard/keypad may be a push button numeric dialing pad, a multi-key keyboard, or one or more other types of keys or buttons, and may also include a joystick-like controller, designated navigation buttons, or any other type of input mechanism. In some examples, the user input may be provided via the input devices 716. In some examples, the input devices 716 may also, or alternately, include the sensors 120, such that sensor data may be provided via the input devices 716.

The machine-readable media 720 may store one or more sets of instructions, such as software or firmware, that embodies any one or more of the methodologies or functions described herein. The instructions may also reside, completely or at least partially, within the memory 704, processor(s) 708, and/or communication interfaces 710 during execution thereof by the computing system 702. The memory 704 and the processor(s) 708 may also constitute machine-readable media 720.

Although the subject matter has been described in language specific to structural features and/or methodological acts, it is to be understood that the subject matter is not necessarily limited to the specific features or acts described above. Rather, the specific features and acts described above are disclosed as example embodiments.

### Exemplary Embodiments

The various techniques described herein may be implemented in any number of example embodiments, including (but not limited to) computer systems, computer-implemented methods, and non-transitory computer-readable media storing computer-executable instructions. The various embodiments described herein may be implemented alone or in combination, and may include vehicle-based implementations (e.g., vehicle-based computer systems and computer-implemented methods executed by vehicle computing systems configured to captured and analyze image data, etc.) and/or non-vehicle-based implementations (e.g., computer systems and computer-implemented methods executed by non-vehicle-based remote servers configured to receive and analyze image data captured by one or more vehicles).

In certain aspects, a vehicle-based computer system may be configured to store image data captured by one or more rear-facing cameras installed on the vehicle, and to transmit the image data to a remote server configured to perform collision analyses, detect high-risk driving scenarios, perform driver assessments, and the like. The computer system may include one or more local or remote processors, severs, sensors, memory units, mobile devices, wearables, smart glasses, smart watches, augmented reality glasses, virtual reality headsets, extended or mixed reality headsets or glasses, digital assistant devices, smart home systems, chatbots, voicebots, ChatGPT bots, and/or other electronic or electrical components, which may be in wired or wireless communication with one another and any of which may function as an input and/or output device. For instance, completed analysis may be presented to a user via VR headsets, AR glasses, chat bots, etc. In one aspect, the computer system may be a vehicle (or vehicle-based) computing system of a vehicle that may include one or more processors, and memory storing computer-executable instructions that, when executed by the one or more processors, cause the one or more processors to: (1) receive image data captured by a rear-facing camera installed on a vehicle; (2) store the image data within a storage unit on the vehicle; (3) detecting an event during operation of the vehicle within a driving environment; and/or (4) in response to detecting the event, transmitting the image data to a remote server. In various examples, the vehicle-based computer system may provide additional, less, or alternate functionality, including any combination of the features and functionality discussed elsewhere herein.

In additional aspects, a vehicle-based computer system may be configured to analyze image data captured by one or more rear-facing cameras installed on the vehicle, in order to determine one or more operations to perform on the vehicle (e.g., risk assessments of driving scenarios, initiating vehicle safety maneuvers, notifications to drivers of high-risk situations, etc.). The computer system may be a vehicle (or vehicle-based) computing system that may include one or more processors, and memory storing computer-executable instructions that, when executed by the one or more processors, cause the one or more processors to: (1) receive, by an image analysis system of a vehicle, image data captured by a rear-facing camera installed on the vehicle; (2) determine, by the image analysis system, a high-risk driving condition, based at least in part on the image data; and/or (3) initiating a control operation on the vehicle, based at least in part on determining the high-risk driving condition. In various examples, the vehicle-based computer system may provide additional, less, or alternate functionality, including any combination of the features and functionality discussed elsewhere herein.

In still further aspects a computer-implemented method may be performed by vehicle computing systems of a vehicle, to store image data captured by rear-facing camera(s) on the vehicle and transmit the image data to a remote server configured to perform collision analyses, detect high-risk driving scenarios, perform driver assessments, etc. The computer-implemented method may be implemented by one or more local or remote processors, severs, sensors, memory units, mobile devices, wearables, smart glasses, smart watches, augmented reality glasses, virtual reality headsets, extended or mixed reality headsets or glasses, digital assistant devices, smart home systems, chatbots, voicebots, ChatGPT bots, and/or other electronic or electrical components, which may be in wired or wireless communication with one another and/or any of which may be utilized for input and/or output devices. For example, in one aspect, the method may include (1) receiving, by a vehicle computing system, image data captured by a rear-facing camera installed on a vehicle; (2) storing, by the vehicle computing system, the image data within a storage unit on the vehicle; (3) detecting, by the vehicle computing system, an event during operation of the vehicle within a driving environment; and/or (4) in response to detecting the event, transmitting the image data to a remote server. The method may include additional, less, or alternate functionality, including that discussed elsewhere herein.

For example, in some aspects, the vehicle-based computing systems described herein may be configured to detect the event by performing at least one of: detecting a collision or a near-miss collision involving the vehicle; detecting damage to the vehicle; detecting a high-risk driving scenario within the driving environment; or determining an expiration of a periodic timer associated with the rear-facing camera.

In some aspects, the vehicle-based computing systems described herein may be configured to detect the event by receiving additional data associated with the image data, from at least one of: a telematics system of the vehicle; a front-facing or side-facing camera of the vehicle; or a road condition or weather condition data source associated with the vehicle. In such aspects, the vehicle-based computing systems may be configured to determine the event, based at least in part on the additional data. Additionally, in some examples, the vehicle-based computing systems may detect, as the event, a collision on an impact surface of the vehicle. In such examples, the vehicle-based computing systems may determine a subset of the additional data, based at least in part on the impact surface of the vehicle, and transmit the subset of the additional data to the remote server.

In some aspects, the vehicle-based computing systems described herein may transmit the image data to the remote server, using one or more communication techniques including transmitting the image data via an Internet connection associated with the vehicle, transmitting the image data via a wireless network connection associated with the rear-facing camera, and/or transmitting the image data via a mobile device of an occupant of the vehicle.

In some aspects, the vehicle-based computing systems described herein may further be configured to determine trailing vehicle data associated with a trailing vehicle perceived within the image data, and transmit the trailing vehicle data to the remote server. Examples of trailing vehicle data may include, but are not limited to, vehicle identifiers of the trailing vehicle, a following distance of the trailing vehicle, a make and/or model of the trailing vehicle, a speed and/or acceleration of the trailing vehicle, and/or behaviors of the driver of the trailing vehicle.

In some examples, the rear-facing camera of the vehicle may correspond to an integrated backup camera of the vehicle. For certain rear-facing cameras, the vehicle computing systems of the vehicle may activate the rear-facing camera in response to the vehicle being put into reverse. Additionally or alternatively, the rear-facing camera of the vehicle may include independently installed and/or retrofit cameras that may be controlled independently of the original equipment manufacturer (OEM) computing systems of the vehicle.

In some aspects, in response to detecting a high-risk driving condition (or other high-risk situation) based upon the image data, the vehicle-based computing system may be configured to automatically perform one or more of: activating a brake light or hazard light on the vehicle; initiating an acceleration maneuver by the vehicle; and/or initiating a steering maneuver by the vehicle. Additionally or alternatively, when detecting a high-risk driving condition based upon the image data, the vehicle-based computing system may be configured to transmit a notification identifying the high-risk driving condition, via an audio or visual system of the vehicle, to a driver of the vehicle. In still other examples, when detecting a high-risk driving condition based upon the image data, the vehicle-based computing system may be configured to determine a deceleration value for a braking maneuver performed by the vehicle.

### Additional Considerations

Although the text herein sets forth a detailed description of numerous different embodiments, it should be understood that the legal scope of the invention is defined by the words of the claims set forth at the end of this patent. The detailed description is to be construed as example only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112 (f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

1. A computing system for on-vehicle event detection using image data from a rear-facing vehicle camera, the computing system comprising:
one or more processors, and
memory operably connected to the one or more processors, the memory storing computer-executable instructions that, when executed by the one or more processors, cause the computing system to perform operations including:
receiving image data captured by a rear-facing camera installed on a vehicle;
storing the image data within a storage unit on the vehicle;
determining an event during operation of the vehicle within a driving environment; and
transmitting, based at least in part on determining the event, the image data to a remote server.

2. The vehicle-based computing system of claim 1, wherein determining the event comprises at least one of:
determining a collision or a near-miss collision involving the vehicle;
determining damage to the vehicle;
determining a high-risk driving scenario within the driving environment; or
determining an expiration of a periodic timer associated with the rear-facing camera.

3. The vehicle-based computing system of claim 1, wherein determining the event comprises:
receiving additional data associated with the image data, from at least one of:
a telematics system of the vehicle;
a front-facing or side-facing camera of the vehicle; or
a road condition or weather condition data source associated with the vehicle;
and
determining the event, based at least in part on the additional data.

4. The vehicle-based computing system of claim 3, wherein the event comprises a collision on an impact surface of the vehicle, and wherein the operations further include:
determining a subset of the additional data, based at least in part on the impact surface of the vehicle; and
transmitting the subset of the additional data to the remote server.

5. The vehicle-based computing system of claim 1, wherein transmitting the image data to the remote server comprises at least one of:
transmitting the image data via an Internet connection associated with the vehicle;
transmitting the image data via a wireless network connection associated with the rear-facing camera; or
transmitting the image data via a mobile device of an occupant of the vehicle.

6. The vehicle-based computing system of claim 1, the operations further including:
determining trailing vehicle data associated with a trailing vehicle perceived within the image data; and
transmitting the trailing vehicle data to the remote server, wherein the trailing vehicle data comprises at least one of:
a vehicle identifier of the trailing vehicle;
a following distance of the trailing vehicle;
a model of the trailing vehicle;
a speed of the trailing vehicle;
an acceleration of the trailing vehicle; or
a behavior of a driver of the trailing vehicle.

7. The vehicle-based computing system of claim 1, wherein the rear-facing camera comprises an integrated backup camera of the vehicle, wherein integrated backup camera is configured to activate the rear-facing camera when the vehicle is put into reverse.

8. The vehicle-based computing system of claim 1, wherein storing the image data comprises:
causing the image data to be retained within the storage unit for a duration of time, based upon determining a driving condition of the vehicle.

9. A vehicle-based computing system for determining high-risk driving conditions based on image data from a rear-facing vehicle camera, the vehicle-based computing system comprising:
one or more processors, and
memory coupled to the one or more processors, the memory storing computer-executable instructions that, when executed by the one or more processors, cause the vehicle-based computing system to perform operations including:
receiving, by an image analysis system of a vehicle, image data captured by a rear-facing camera installed on the vehicle;
determining, by the image analysis system, a high-risk driving condition, based at least in part on the image data; and
initiating a control operation on the vehicle, based at least in part on determining the high-risk driving condition.

10. The vehicle-based computing system of claim 9, wherein initiating the control operation on the vehicle comprises at least one of:
activating a brake light or hazard light on the vehicle;
initiating an acceleration maneuver by the vehicle; or
initiating a steering maneuver by the vehicle.

11. The vehicle-based computing system of claim 9, wherein initiating the control operation on the vehicle comprises:
transmitting a notification identifying the high-risk driving condition, via an audio or visual system of the vehicle, to a driver of the vehicle.

12. The vehicle-based computing system of claim 9, wherein initiating the control operation on the vehicle comprises:
determining a deceleration value for a braking maneuver performed by the vehicle.

13. The vehicle-based computing system of claim 9, the operations further including, based at least in part on determining the high-risk driving condition:
storing the image data within a storage unit on the vehicle; and
transmitting the image data to a remote server.

14. The vehicle-based computing system of claim 9, wherein the rear-facing camera comprises an integrated backup camera of the vehicle, wherein integrated backup camera is configured to activate the rear-facing camera when the vehicle is put into reverse.

15. The vehicle-based computing system of claim 9, the operations further including:
identifying a trailing vehicle within the image data; and
determining the high-risk driving condition, based upon at least one of:
a following distance of the trailing vehicle;
a speed of the trailing vehicle;
an acceleration of the trailing vehicle; or
a driver behavior or the trailing vehicle.

16. The vehicle-based computing system of claim 9, wherein determining the high-risk driving condition further comprises:
receiving additional data associated with the image data, from at least one of:
a telematics system of the vehicle;
a front-facing or side-facing camera of the vehicle; or
a road condition or weather condition data source associated with the vehicle;
and
determining the high-risk driving condition, based at least in part on the additional data.

17. A computer-implemented method of on-vehicle event detection using image data from a rear-facing vehicle camera, the method comprising:
receiving, by a vehicle computing system, image data captured by a rear-facing camera installed on a vehicle;
storing, by the vehicle computing system, the image data within a storage unit on the vehicle;
determining, by the vehicle computing system, an event during operation of the vehicle within a driving environment; and
transmitting, based at least in part on determining the event, the image data to a remote server.

18. The computer-implemented method of claim 17, wherein transmitting the image data to the remote server comprises at least one of:
transmitting the image data via an Internet connection associated with the vehicle;
transmitting the image data via a wireless network connection associated with the rear-facing camera; or
transmitting the image data via a mobile device of an occupant of the vehicle.

19. The computer-implemented method of claim 17, further comprising:
determining trailing vehicle data associated with a trailing vehicle perceived within the image data; and
transmitting the trailing vehicle data to the remote server, wherein the trailing vehicle data comprises at least one of:
a vehicle identifier of the trailing vehicle;
a following distance of the trailing vehicle;
a model of the trailing vehicle;
a speed of the trailing vehicle;
an acceleration of the trailing vehicle; or
a behavior of a driver of the trailing vehicle.

20. The computer-implemented method of claim 17, wherein detecting the event comprises:
receiving additional data associated with the image data, from at least one of:
a telematics system of the vehicle;
a front-facing or side-facing camera of the vehicle; or
a road condition or weather condition data source associated with the vehicle;
and
determining the event, based at least in part on the additional data.
